(19) United States
(12) Patent Application Publication
(10) Pub. No.: US 2025/0150213 A1
(43) Pub. Date: May 8, 2025

(54) HYBRID AUTOMATIC REPEAT REQUEST CODEBOOKS FOR SIDELINK COMMUNICATIONS

(71) Applicant: QUALCOMM INCORPORATED, San Diego, CA (US)

(72) Inventors: Shaozhen Guo, Beijing (CN); Changlong Xu, Beijing (CN); Jing Sun, San Diego, CA (US); Xiaoxia Zhang, San Diego, CA (US); Chih-Hao Liu, San Diego, CA (US); Hao Xu, Beijing (CN); Luanxia Yang, Beijing (CN); Siyi Chen, Beijing (CN)

(21) Appl. No.: 18/835,282

(22) PCT Filed: Mar. 17, 2022
(86) PCT No.: PCT/CN2022/081376

§ 371 Date: Aug. 1, 2024

(51) Int. Cl. H04L 1/1829; H04W 72/23

(52) U.S. Cl. CPC H04L 1/1854; H04W 72/23

(57) ABSTRACT

Methods, systems, and devices for wireless communications are described. A user equipment (UE) may receive configuration information indicating a sidelink resource pool, a time gap, and a periodicity of feedback occasions. The UE may generate feedback bits associated with multiple received sidelink messages based on the configuration information. The UE may transmit the feedback bits in a single, multi-bit feedback message according to one or more rules. In some examples, the UE may drop one or more sets of feedback bits (e.g., in the case of a collision of too many feedback messages in a single slot) based on a weighted average priority level of one or more valid feedback bits in each of multiple sets of feedback bits.

### CROSS REFERENCE

The present application is a 371 national stage filing of International PCT Application No. PCT/CN2022/081376 by Guo et al. entitled “HYBRID AUTOMATIC REPEAT REQUEST CODEBOOKS FOR SIDELINK COMMUNICATIONS,” filed Mar. 17, 2022, which is assigned to the assignee hereof, and which is expressly incorporated by reference in its entirety herein.

### FIELD OF TECHNOLOGY

The following relates to wireless communications, including hybrid automatic repeat request (HARQ) codebooks for sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support hybrid automatic repeat request (HARQ) codebooks for sidelink communications. A user equipment (UE) may receive configuration information indicating a sidelink resource pool, a time gap, and a periodicity of feedback occasions. The UE may generate feedback bits associated with multiple received sidelink messages based on the configuration information. The UE may transmit the feedback bits in a single, multi-bit feedback message according to one or more rules. In some examples, the UE may drop one or more sets of feedback bits (e.g., in the case of a collision of too many feedback messages in a single slot) based on a weighted average priority level of one or more valid feedback bits in each of multiple sets of feedback bits.

A method for wireless communications at a first wireless device is described. The method may include receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool, generating a set of multiple feedback bits corresponding to a set of candidate slots of the set of multiple slots based on the time gap and the periodicity of the set of feedback occasions, and transmitting a feedback message including one or more indicators of the set of multiple feedback bits on a feedback occasion of the set of feedback occasions that is located within a first slot of the sidelink resource pool.

An apparatus for wireless communications at a first wireless device is described. The apparatus may include a processor, memory coupled with the processor, and instructions stored in the memory. The instructions may be executable by the processor to cause the apparatus to receive an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool, generate a set of multiple feedback bits corresponding to a set of candidate slots of the set of multiple slots based on the time gap and the periodicity of the set of feedback occasions, and transmit a feedback message including one or more indicators of the set of multiple feedback bits on a feedback occasion of the set of feedback occasions that is located within a first slot of the sidelink resource pool.

Another apparatus for wireless communications at a first wireless device is described. The apparatus may include means for receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool, means for generating a set of multiple feedback bits corresponding to a set of candidate slots of the set of multiple slots based on the time gap and the periodicity of the set of feedback occasions, and means for transmitting a feedback message including one or more indicators of the set of multiple feedback bits on a feedback occasion of the set of feedback occasions that is located within a first slot of the sidelink resource pool.

A non-transitory computer-readable medium storing code for wireless communications at a first wireless device is described. The code may include instructions executable by a processor to receive an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool, generate a set of multiple feedback bits corresponding to a set of candidate slots of the set of multiple slots based on the time gap and the periodicity of the set of feedback occasions, and transmit a feedback message including one or more indicators of the set of multiple feedback bits on a feedback occasion of the set of feedback occasions that is located within a first slot of the sidelink resource pool.

In some examples of the method, apparatuses, and non-transitory computer-readable medium described herein, the set of candidate slots of the set of multiple slots includes one or more slots located between a first candidate slot occurring at the first number of slots before the first slot and a second candidate slot occurring at a second number of slots before the first slot.

In some examples of the method, apparatuses, and non-transitory computer-readable medium described herein, the second number of slots may be equal to one slot less than a sum of the first number of slots and the periodicity of the set of feedback occasions.

In some examples of the method, apparatuses, and non-transitory computer-readable medium described herein, the second number of slots may be equal to one slot less than a product of the periodicity of the set of feedback occasions and a number of feedback occasions associated with the feedback occasion of the set of feedback occasions.

In some examples of the method, apparatuses, and non-transitory computer-readable medium described herein, receiving the indication of the configuration may include operations, features, means, or instructions for receiving a radio resource control message indicating the number of feedback occasions.

In some examples of the method, apparatuses, and non-transitory computer-readable medium described herein, the number of feedback occasions may be predefined.

Some examples of the method, apparatuses, and non-transitory computer-readable medium described herein may further include operations, features, means, or instructions for ordering the one or more indicators of the set of multiple feedback bits in the feedback message according to a descending order of number of slots between each candidate slot of the set of candidate slots and the first slot, where each feedback bit of the set of multiple feedback bits may be associated with a respective candidate slot of the set of candidate slots.

Some examples of the method, apparatuses, and non-transitory computer-readable medium described herein may further include operations, features, means, or instructions for performing a listen-before-talk procedure, where the sidelink resource pool includes unlicensed spectrum, and where transmitting the feedback message may be based on determining that the listen-before-talk procedure may be successful.

In some examples of the method, apparatuses, and non-transitory computer-readable medium described herein, generating the set of multiple feedback bits may include operations, features, means, or instructions for generating the set of multiple feedback bits associated with the set of candidate slots corresponding to a first priority level or a second priority level, where the first priority level may be higher than the second priority level.

Some examples of the method, apparatuses, and non-transitory computer-readable medium described herein may further include operations, features, means, or instructions for receiving an indication of a second configuration to generate one set of multiple feedback bits for the first priority level and the second priority level, where generating the set of multiple feedback bits may be based on the second configuration.

In some examples of the method, apparatuses, and non-transitory computer-readable medium described herein, generating the set of multiple feedback bits may include operations, features, means, or instructions for generating the set of multiple feedback bits associated with transmissions corresponding to a first priority level received over the set of candidate slots and generating a second set of multiple feedback bits associated with transmissions corresponding to a second priority level received over a second set of candidate slots, where the first priority level may be higher than the second priority level.

Some examples of the method, apparatuses, and non-transitory computer-readable medium described herein may further include operations, features, means, or instructions for receiving an indicator of a number of priority levels including the first priority level and the second priority level, where generating the set of multiple feedback bits and generating the second set of multiple feedback bits may be based on the indicator of the number of priority levels.

Some examples of the method, apparatuses, and non-transitory computer-readable medium described herein may further include operations, features, means, or instructions for receiving an indicator of a threshold priority level and determining that the first priority level satisfies the threshold priority level and that the second priority level does not satisfy the threshold priority level, where generating the set of multiple feedback bits and generating the second set of multiple feedback bits may be based on the determining.

Some examples of the method, apparatuses, and non-transitory computer-readable medium described herein may further include operations, features, means, or instructions for receiving an indication of a third configuration to generate the set of multiple feedback bits and the second set of multiple feedback bits corresponding to respective priority levels of a set of multiple priority levels including the first priority level and the second priority level, where generating the set of multiple feedback bits and generating the second set of multiple feedback bits may be based on the third configuration.

A method for wireless communications at a wireless device is described. The method may include receiving an indicator of a configuration of a sidelink resource pool including a set of multiple slots allocated for sidelink communication, the sidelink resource pool including a set of periodic feedback occasions, generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots, and transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

An apparatus for wireless communications at a wireless device is described. The apparatus may include a processor, memory coupled with the processor, and instructions stored in the memory. The instructions may be executable by the processor to cause the apparatus to receive an indicator of a configuration of a sidelink resource pool including a set of multiple slots allocated for sidelink communication, the sidelink resource pool including a set of periodic feedback occasions, generate, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots, and transmit the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

Another apparatus for wireless communications at a wireless device is described. The apparatus may include means for receiving an indicator of a configuration of a sidelink resource pool including a set of multiple slots allocated for sidelink communication, the sidelink resource pool including a set of periodic feedback occasions, means for generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots, and means for transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

A non-transitory computer-readable medium storing code for wireless communications at a wireless device is described. The code may include instructions executable by a processor to receive an indicator of a configuration of a sidelink resource pool including a set of multiple slots allocated for sidelink communication, the sidelink resource pool including a set of periodic feedback occasions, generate, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots, and transmit the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

Some examples of the method, apparatuses, and non-transitory computer-readable medium described herein may further include operations, features, means, or instructions for determining a first average weight value for the first set of candidate slots based on the first priority level and the number of detected transmissions associated with the first set of candidate slots and a second average weight value for the second set of candidate slots based on the second priority level and the number of detected transmissions associated with the second set of candidate slots.

Some examples of the method, apparatuses, and non-transitory computer-readable medium described herein may further include operations, features, means, or instructions for refraining from transmitting the second set of multiple feedback bits during the first feedback occasion based on the first average weight value and the second average weight value.

Some examples of the method, apparatuses, and non-transitory computer-readable medium described herein may further include operations, features, means, or instructions for identifying a collision between the first set of multiple feedback bits and the second set of multiple feedback bits during the first feedback occasion and determining the first average weight value and the second average weight value based on identifying the collision.

Some examples of the method, apparatuses, and non-transitory computer-readable medium described herein may further include operations, features, means, or instructions for determining a quantity of feedback messages for transmission in the first feedback occasion and determining the first average weight value and the second average weight value based on determining that the quantity of feedback messages exceeds a threshold.

In some examples of the method, apparatuses, and non-transitory computer-readable medium described herein, the first priority level may be higher than the second priority level.

### BRIEF DESCRIPTION OF THE DRAWINGS

FIG. 1 illustrates an example of a wireless communications system that supports hybrid automatic repeat request (HARQ) codebooks for sidelink communications in accordance with one or more aspects of the present disclosure.

FIG. 2 illustrates an example of a wireless communications system that supports HARQ codebooks for sidelink communications in accordance with one or more aspects of the present disclosure.

FIG. 3 illustrates an example of a timeline that supports HARQ codebooks for sidelink communications in accordance with one or more aspects of the present disclosure.

FIG. 4 illustrates an example of a timeline that supports HARQ codebooks for sidelink communications in accordance with one or more aspects of the present disclosure.

FIG. 5 illustrates an example of a timeline that supports HARQ codebooks for sidelink communications in accordance with one or more aspects of the present disclosure.

FIG. 6 illustrates an example of a timeline that supports HARQ codebooks for sidelink communications in accordance with one or more aspects of the present disclosure.

FIG. 7 illustrates an example of a feedback weighting scheme that supports HARQ codebooks for sidelink communications in accordance with one or more aspects of the present disclosure.

FIG. 8 illustrates an example of a process flow that supports HARQ codebooks for sidelink communications in accordance with one or more aspects of the present disclosure.

FIG. 9 illustrates an example of a process flow that supports HARQ codebooks for sidelink communications in accordance with one or more aspects of the present disclosure.

FIGS. 10 and 11 show block diagrams of devices that support HARQ codebooks for sidelink communications in accordance with one or more aspects of the present disclosure.

FIG. 12 shows a block diagram of a communications manager that supports HARQ codebooks for sidelink communications in accordance with one or more aspects of the present disclosure.

FIG. 13 shows a diagram of a system including a device that supports HARQ codebooks for sidelink communications in accordance with one or more aspects of the present disclosure.

FIGS. 14 through 17 show flowcharts illustrating methods that support HARQ codebooks for sidelink communications in accordance with one or more aspects of the present disclosure.

### DETAILED DESCRIPTION

In some wireless communications systems, feedback signaling may be requested for transmission via a physical sidelink feedback channel (PSFCH). PSFCH resources may be configured within a resource pool, which may be a subset of slots of a physical sidelink shared channel (PSSCH) defined by a configuration such as a bitmap. A sidelink UE may receive a sidelink message during a first slot within the sidelink resource pool, and may transmit a feedback message associated with the first slot during a feedback occasion located in a second slot a minimum time gap after the first slot. Such a PSFCH may carry a single bit indicating feedback information (e.g., an acknowledgment (ACK) message or a negative acknowledgement (NACK) message) for a message received in the first slot. However, the sidelink UE may receive a large amount of sidelink data (e.g., a continuous stream of sidelink data, large amounts of sidelink data, or sidelink data over multiple component carriers via sidelink carrier aggregation deployments). In such examples, individual one-bit feedback messages may be inefficient (e.g., may increase signaling overhead, may be frequency division multiplexed (FDM) resulting in inefficient use of available resources, or may result in increased latency).

Additionally, or alternatively, the sidelink UE may operate in unlicensed spectrum, and may perform a listen-before-talk (LBT) procedure prior to transmitting a feedback message. If the LBT procedure fails (e.g., and the PSFCH is unavailable), then the UE maybe unable to transmit the feedback message (e.g., even if the UE successfully received one or more sidelink messages). In the absence of feedback information, the source UE may retransmit one or more sidelink messages, resulting in unnecessary retransmissions, inefficient use of resources, increased latency, or decreased user experience.

According to techniques described herein, a wireless communications system may support multi-bit PSFCH transmissions. The UE may generate multiple feedback bits for a feedback message (e.g., for transmission on a PSFCH), and may transmit the feedback message according to a codebook, based on one or more parameters. For example, the UE may receive (e.g., from a network entity or based on preconfiguration) a sidelink resource pool bitmap indicating one or more slots (e.g., logical slots) allocated for sidelink communications, a periodicity of a set of feedback occasions (e.g., resources within the sidelink resource pool on which the set of PSFCHs are scheduled), and a value of a time gap (e.g., a minimum time gap) between a candidate slot on which the UE may receive sidelink messages and the feedback occasion on which the feedback message is to be transmitted. The UE may generate feedback bits of a feedback message for a set of candidate slots of the sidelink resource pool based on the received parameters. The UE may transmit the feedback message during a first feedback occasion.

The feedback message may include a set of feedback bits associated with a set of candidate slots. The last candidate slot of the set of candidate slots may occur at least the minimum time gap prior to a first slot including the first feedback occasion. The number of feedback bits in the feedback message may be equal to a number of slots of the periodicity of the feedback occasions (e.g., or a multiple of the periodicity associated with a number of PSFCH occasions). For instance, for a minimum time gap of two slots, and a feedback occasion periodicity of four slots, the UE may generate a feedback message including four bits: Each bit may correspond to one of 4 candidate slots that are at least the time gap (e.g., two slots) prior to the first slot in which the feedback message is transmitted (e.g., if the UE transmits the feedback message in a PSFCH occasion during slot n, and the time gap is equal to two slots, then each of the 4 bits may correspond, in descending order of amount of time from slot 0, to slots n−5, n−4, n−3, and n−2). In some examples, the base station may configure the sidelink UE to generate the codebook according to a multiple of the feedback occasion periodicity (resulting in retransmission of portions of the feedback bits).

In some examples, the UE may generate multiple feedback messages for transmission during a same feedback occasion. In such examples, the UE may drop one of the feedback messages based on a priority level of transmissions received during candidate slots associated with the feedback messages. For example, the UE may determine a weighted average priority of transmissions received during candidate slots associated with the first feedback message and a weighted average priority of transmissions received during candidate slots associated with the second feedback message, and may drop the feedback message having the higher weighted average priority value (e.g., where a lower priority value indicates a higher priority level and a higher priority value indicates a lower priority level).

Aspects of the disclosure are initially described in the context of wireless communications systems. Aspects of the disclosure are further illustrated by and described with reference to wireless communications systems, timelines, feedback weighting schemes, and process flows. Aspects of the disclosure are further illustrated by and described with reference to apparatus diagrams, system diagrams, and flowcharts that relate to HARQ codebooks for sidelink communications.

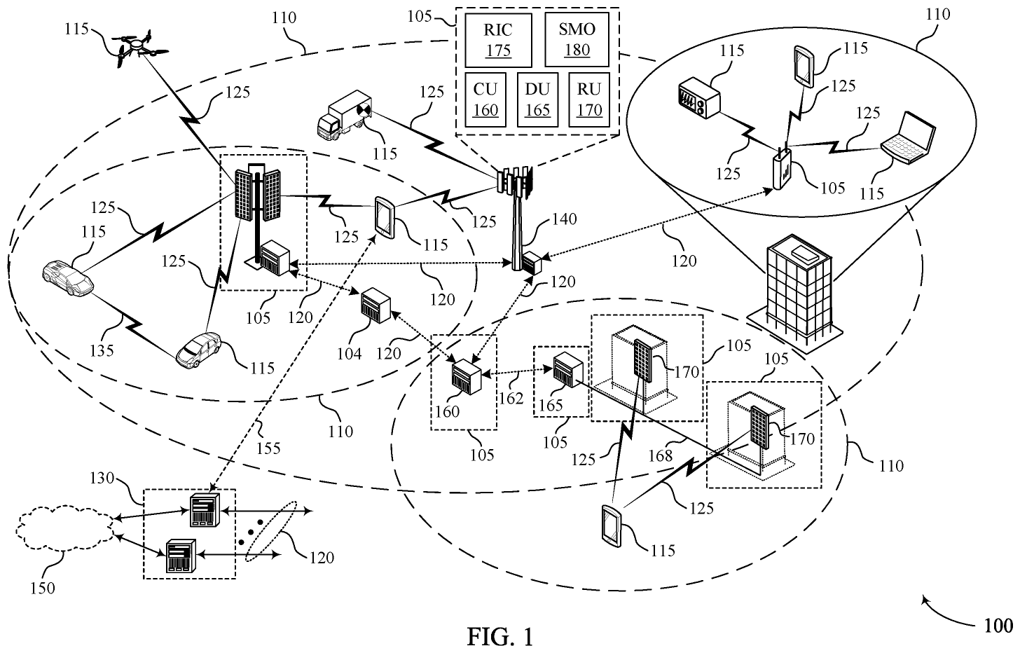

FIG. 1 illustrates an example of a wireless communications system 100 that supports hybrid automatic repeat request (HARQ) codebooks for sidelink communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (LAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support HARQ codebooks for sidelink communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, wireless communications system 100 may support physical sidelink control channel (PSCCH) and physical sidelink shared channel (PSSCH) transmissions, and ACK or NACK transmissions for a PSSCH may be requested for transmission in a PSFCH. PSFCH resources may be selected (e.g., determined, assigned) from a resource pool. In some cases, the resource pool is not a dedicated PSFCH resource pool (e.g., the resources in the pool may be commonly used by multiple UEs). In some examples, a period in slots (e.g., indicated via a higher layer parameter, such as periodPSFCHresource) for a PSFCH transmission in a resource pool may be defined. Supported periods may include 0, 1, 2, and 4 (e.g., where a period of 0 slots may indicate no PSFCH). PSFCH transmission timing may be constrained such that a feedback message may be transmitted during a first PSFCH resource after a PSSCH and after a time gap (e.g., a minimum time gap, which may be defined by a parameter such as MinTimGapPSFCH) after the PSSCH. A set of physical resource blocks (PRBs) for a PSFCH in a slot (e.g., M_{PRB,set}^{PSFCH}) may be split between a number of PSSCH slots corresponding to the PSFCH slot (e.g., N_{PSSCH}^{PSFCH}) and a number of subchannels (e.g., PSSCH subchannels N_{subch}) in a slot. In such examples, each subchannel/slot may have

$${M}_{subch , slot}^{PSFCH} = \frac{{M}_{PRB , set}^{PSFCH}}{{N}_{PSSCH}^{PSFCH} \times {N}_{subch}} PRBs .$$

Time first mapping from PSSCH resources to PSFCH PRBs may be defined or supported. PSFCH resource pools may have a size of R_{PRB,CS}^{PSFCH}=N_{type}^{PSFCH}×N_{CS}^{PSFCH}×M_{subch,slot}^{PSFCH}, where N_{CS}^{PSFCH} represents a number of CS pairs, configured per resource pool (e.g., each pair may be for an ACK/NACK indication, and may be one bit), N_{type}^{PSFCH} is 1 or N_{subch}^{PSSCH} (e.g., possibly indicating whether the PSFCH resource pool is shared or not for the subchannels in a PSSCH slot). Within the resource pool, a PSFCH resource may be indexed from a PRB index, and additionally or alternatively indexed using a CS pair index.

In some examples, PSFCH resource determination may be determined according to (P_{ID}+M_{ID})mod R_{PRB,CS}^{PSFCH}, where P_{ID} represents a physical source identifier from a sidelink control information (SCI) message (e.g., SCI 2-A or SCI 2-B) for PSSCH, and where M_{ID} represents 0 or an identity of the UE receiving the PSSCH. For example, for unicast or NACK based transmissions, M_{ID}=0, and the UE may transmit an ACK/NACK or a NACK only at a source identifier dependent resource in the pool. For groupcast scenarios, each receiving UE 115 may select one resource in the pool and transmit an ACK/NACK.

In some examples, a UE 115 may transmit multiple bits sidelink ACK/NACK messages. For example, a PSFCH may be a single symbol of a single RB (e.g., with a format similar to a control message having format 0). Such a PSFCH message may carry a single bit. If a UE 115 transmits multiple bits indicating multiple ACK/NACK messages, then the UE 115 may frequency division multiplex (FDM) multiple one-bit PSFCH messages. This may include a case in which the UE 115 receives multiple PSSCH transmissions from a same source UE 115, but the PSSCHs may have a PSFCH hashed to a same PSFCH location (e.g., when the PSFCH period is two slots or four slots). Such cases may also include a case in which a UE 115 receives multiple PSSCHs from different source UEs 115, and transmits PSFCH messages to each of the source UEs. A UE 115 may have a capability defining how many PSFCH messages or transmissions a UE 115 is capable of multiplexing in a same symbol. Multiplexing single-bit PSFCH messages may result in inefficient or unreliable transmission of ACK/NACK information.

In some examples, as described herein, a wireless communications system 100 may support multi-bit PSFCH transmissions. A UE 115 may receive multiple PSSCH transmissions, and may generate multiple feedback bits for a feedback message (e.g., for transmission on a PSFCH). The UE 115 may transmit the feedback message according to a codebook, based on one or more parameters. For example, the UE 115 may receive (e.g., from a network entity 105 or based on preconfiguration) a sidelink resource pool bitmap indicating one or more slots (e.g., logical slots) allocated for sidelink communications, a periodicity of a set of feedback occasions (e.g., resources within the sidelink resource pool on which the set of PSFCHs are scheduled), and a value of a minimum time gap between a candidate slot on which the UE 115 may receive sidelink messages and the feedback occasion on which the feedback message is to be transmitted. The UE 115 may generate feedback bits of a feedback message for a set of candidate slots of the sidelink resource pool based on the received parameters. The UE 115 may transmit the feedback message during a first feedback occasion.

The feedback message may include a set of feedback bits associated with a set of candidate slots. The last candidate slot of the set of candidate slots may occur at least the minimum time gap prior to a first slot including the first feedback occasion. The number of feedback bits in the feedback message may be equal to a number of slots of the periodicity of the feedback occasions (e.g., or a multiple of the periodicity associated with a number of PSFCH occasions). For instance, for a minimum time gap of two slots, and a feedback occasion periodicity of four slots, the UE 115 may generate a feedback message including four bits where each bit may correspond to one of 4 candidate slots that are at least the time gap (e.g., two slots) prior to the first slot in which the feedback message is transmitted (e.g., if the UE 115 transmits the feedback message in a PSFCH occasion during slot n, and the time gap is equal to two slots, then each of the 4 bits may correspond, in descending order of amount of time from slot 0, to slots n−5, n−4, n−3, and n−2). In some examples, the base station may configure the sidelink UE to generate the codebook according to a multiple of the feedback occasion periodicity (resulting in retransmission of portions of the feedback bits).

In some examples, the UE 115 may generate multiple feedback messages for transmission during a same feedback occasion. In such examples, the UE 115 may drop one of the feedback messages based on a priority level of transmissions received during candidate slots associated with the feedback messages. For example, the UE 115 may determine a weighted average priority of transmissions received during candidate slots associated with the first feedback message and a weighted average priority of transmissions received during candidate slots associated with the second feedback message, and may drop the feedback message having the higher weighted average priority value (e.g., where a lower priority value indicates a higher priority level and a higher priority value indicates a lower priority level).

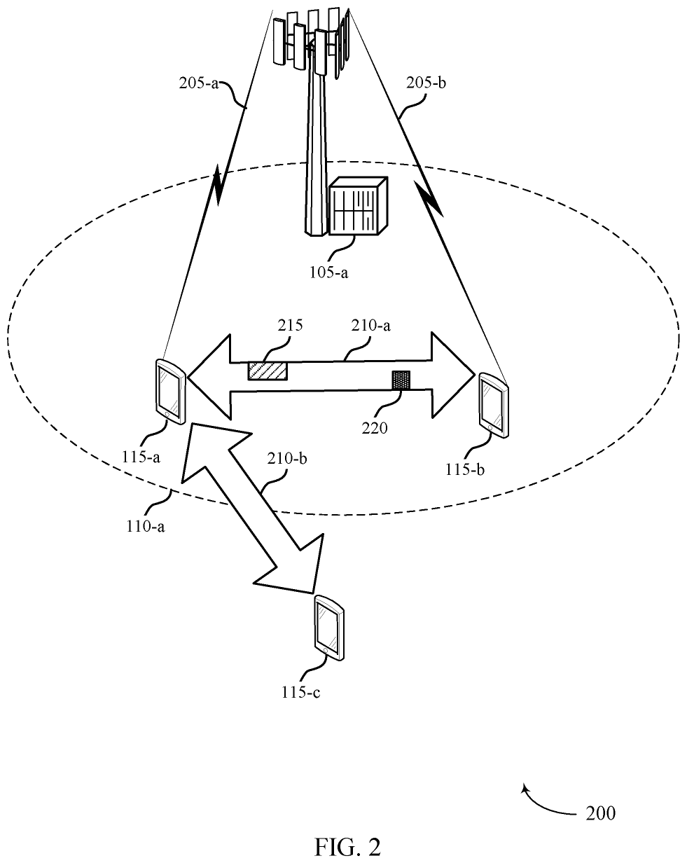

FIG. 2 illustrates an example of a wireless communications system 200 that supports HARQ codebooks for sidelink communications in accordance with one or more aspects of the present disclosure. Wireless communications system 200 may include a network entity 105-b (e.g., a base station, or a functionality of a base station, such as a DU functionality, a CU functionality, or an RU functionality), or any other network entity (e.g., a remote radio head (RRH), a roadside unit (RSU), a network controlled entity such as a soft access point (AP), a distributed or disaggregated aspect of a network, or any combination thereof).

The network entity 105-a may communicate with one or more UEs 115 (e.g., the UE 115-a and the UE 115-b) located within a coverage area 110-a via communication links 205 (e.g., Uu interfaces). For example, the network entity 105-a may communicate with the UE 115-a via wireless communication link 205-a, and may communicate with the UE 115-b via the wireless communication link 205-b. In some examples, UEs 115 may communicate with each other via sidelinks 210 (e.g., the UE 115-a may communicate with the UE 115-b via the sidelink 210-a, and may communicate with the UE 115-c (e.g., which may be located outside of the coverage area 110-a) via the sidelink 210-b.

In some examples, a source UE 115 (e.g., the UE 115-a) may transmit one or more sidelink messages 215 on a PSSCH. The UE 115-b may generate one or more feedback messages 220, and may transmit the one or more feedback messages 220 to the UE 115-a, indicating successful or failed reception of the sidelink messages 215. In some examples, as described in greater detail with reference to FIG. 1, the UE 115-b may generate individual (e.g., one-bit) feedback messages 220 for each received sidelink message 215. In some examples, the UE 115-b may multiplex (e.g., FDM) the multiple individual feedback message 220 across multiple PSFCHs. However, such multiplexing may result in inefficient use of available system resources, increased latency, or excessive power expenditures.

In some examples, the UE 115-b may receive a large number of sidelink messages 215 (e.g., may receive continuous stream of PSSCH). For instance, sidelink communication may be performed in an eMBB use case (e.g., a continuous stream of PSSCH transmissions may be provided to a same destination node, such as the UE 115-b). Additionally, or alternatively, the UEs 115 may perform sidelink communications over multiple component carriers in a sidelink carrier aggregation mode, resulting in increased throughput, and a large number of ACK/NACK bits generated for feedback messages 220. In such examples, single-bit individual feedback messages may be inefficient, or may increase system latency.

In some examples, the UE 115-a and the UE 115-b may communicate via sidelink resources in an unlicensed band. In such examples, frequent PSFCH opportunities may not be configured or may not be available (e.g., possible PSFCH transmissions may be more sparse than other licensed spectrum configurations, or may occur less often than every four slots). If the UE 115-b is unable to gain access to unlicensed sidelink resources (e.g., if an LBT procedure fails), then the UE 115-b may be unable to transmit one or more feedback messages 220, which may result in unnecessary retransmissions of sidelink messages 215. This may in turn result in increased system latency, increased delays, and poor user experience. However, if a UE 115-b supports multi-bit PSFCH transmissions, as described herein, then a number of multiplexed (e.g., FDM) PSFCH transmission may be reduced, resulting in more efficient use of available resources, more reliable communications, decreased numbers of failed communications and retransmissions, decreased system latency, or improved user experience.

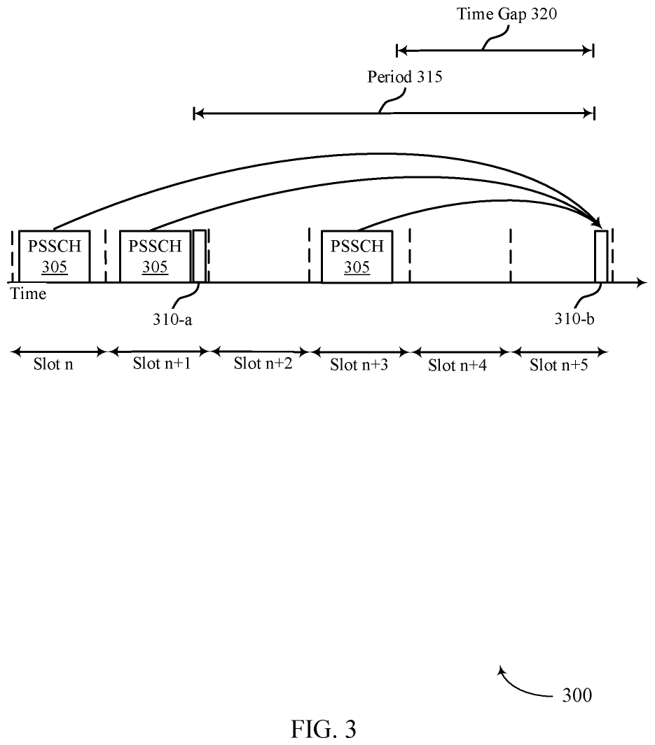

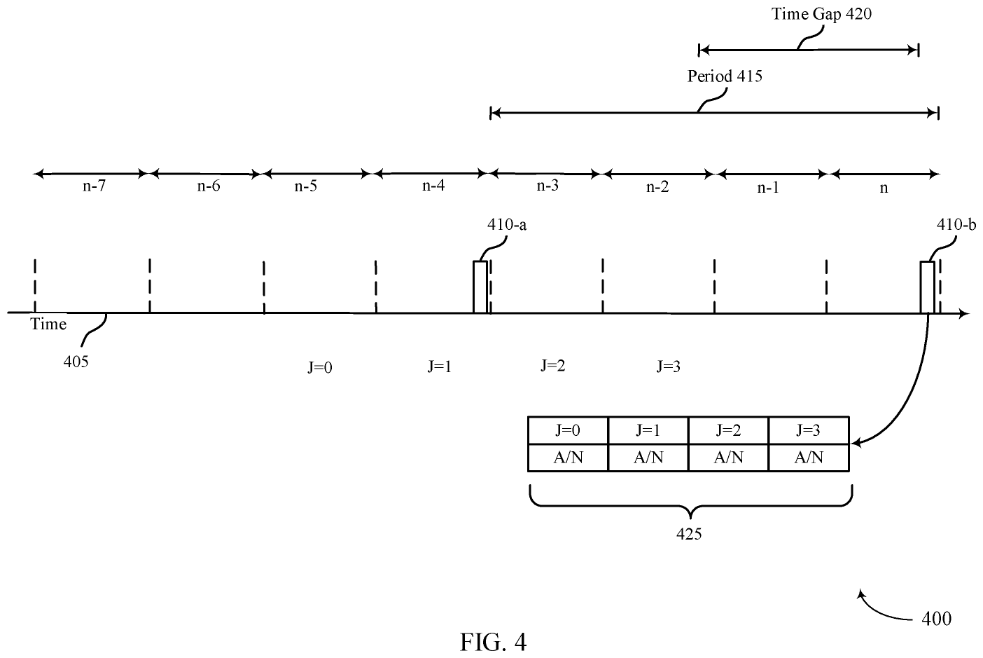

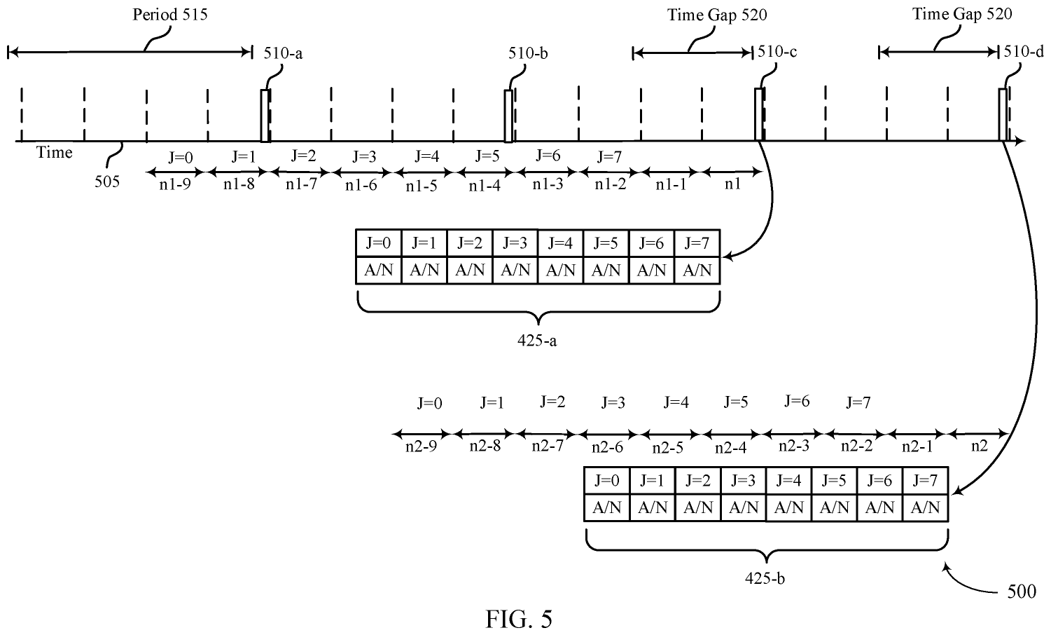

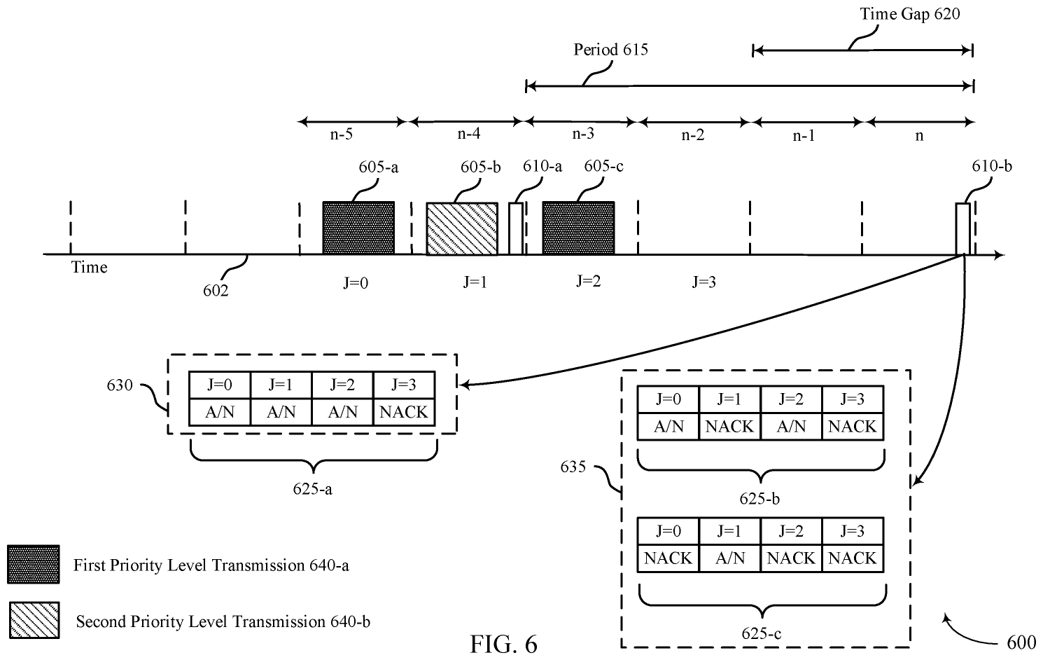

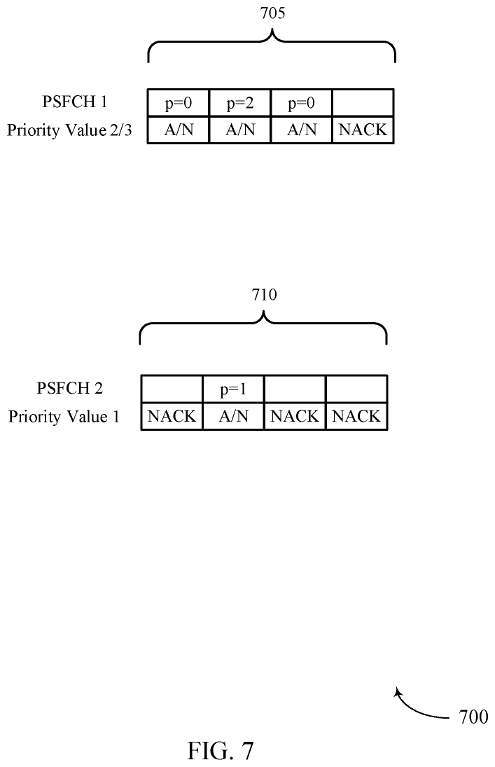

In some examples, as described in greater detail with reference to FIG. 3, a UE 115-b may receive multiple sidelink messages 215, and may generate a multi-bit feedback message according to a multi-bit codebook. The UE 115-b may transmit the feedback message 220 (e.g., including multiple feedback bits) to the UE 115-a during a PSFCH occasion. In some examples, the UE 115-b may receive (e.g., from the network entity 105-a via the communication link 205-b) configuration information, which may include a sidelink resource pool, a periodicity of PSFCH occasions, a time gap (e.g., a minimum time gap), or a combination thereof. In some examples, the UE 115-b may generate feedback bits associated with candidate slots, and may order the feedback bits according to techniques described herein to clearly indicate an ACK or NACK for different slots of a PSSCH. The UE 115-a may receive and decode the multi-bit feedback message, and may effectively determine whether to retransmit one or more sidelink messages 215 based thereon. A multi-bit feedback message 220 is described with reference to FIG. 3. Techniques for generating such a feedback message are described with reference to FIG. 4. Techniques for generating feedback messages for transmission on unlicensed spectrum (e.g., and increasing a likelihood of successful transmission and reception of such feedback messages 220) are described with reference to FIG. 5. Techniques for codebook generation and transmission of feedback messages 220 associated with different priority sidelink messages 215 are described with reference o FIG. 6. Addressing conflicts or prioritization of codebooks and feedback messages 220 are described with reference to FIG. 7.

FIG. 3 illustrates an example of a timeline 300 that supports HARQ codebooks for sidelink communications in accordance with one or more aspects of the present disclosure. Timeline 300 may be implemented by one or more wireless devices, which may be examples of corresponding devices described with reference to FIGS. 1-2. For instance, timeline 300 may be implemented by a transmitting sidelink UE (e.g., a UE 115-a) and a receiving sidelink UE (e.g., a UE 115-b). In some examples, one or more of the UEs may be in communication with a network entity (e.g., a network entity 105-a) via a communication link such as a Uu link. A UE that transmits a sidelink message (e.g., the UE 115-a) may be referred to a source UE. A UE that receives the sidelink message (e.g., and transmits a corresponding feedback message) may be referred to as a destination UE.

A source UE may transmit one or more sidelink messages on a PSSCH 305 (e.g., in various sidelink slots). For example, a network entity may configure one or more UEs with a sidelink resource pool including one or more slots (e.g., slot n, slot n+1, slot n+2, etc.). During the sidelink slots, the source UE may transmit sidelink messages to a destination UE via the PSSCH 305 (e.g., during slot n, slot n+1, and slot n+3). The source UE and the destination UE may be any type of UE (e.g., a smart phone, a wearable device, a V2X device, among other examples).

If the source UE transmits multiple sidelink messages on PSSCH 305 to the destination UE, then the destination UE may transmit a feedback message (e.g., via a PSFCH occasion 310) that includes feedback information for the multiple received sidelink messages (e.g., instead of individual, one-bit, feedback messages for each received sidelink message). The destination UE may be configured with information regarding a period 315 associated with PSFCH occasions 310. For instance, where period 315 is equal to four slots, then the destination UE may identify sidelink resources (e.g., from a configured pool of sidelink resources) in which to transmit a feedback message during a periodic PSFCH occasion 310 (e.g., PSFCH occasion 310-a may be located in slot n+1 and PSFCH occasion 310-b may be located four slots away in slot n+5). The destination UE may also be configured with a time gap 320 (e.g., a minimum amount of time after a PSSCH 305 after which the destination UE is capable of generating and transmitting a feedback bit associated with the PSSCH 305). In some examples, as described in greater detail with reference to FIG. 4, each bit of the multiple bits in a feedback message may correspond to respective PSSCH transmissions from the same source UE. For instance, the destination UE may generate a feedback message for one or more slots on which PSSCH transmissions were received (e.g., that occur prior to the time gap 320). A first feedback bit may be associated with the PSSCH 305 in slot n, a second feedback bit may be associated with the PSSCH 305 in slot n+1, a third feedback bit (e.g., a NACK based on the absence of a PSSCH 305) may be associated with slot n+2, and a fourth feedback bit may be associated with slot n+3. The feedback message transmitted during PSFCH occasion 310-b may not include any feedback bits for slots that fall within the time gap 320 prior to the slot n+5 in which the PSFCH occasion 310-b is located (e.g., the feedback message may not include any feedback bits associated with slot n+4 or the slot n+5).

In some examples, as described in greater detail with reference to FIG. 5, the destination UE (e.g., and the source UE) may operate on unlicensed sidelink resources. In such examples, the destination UE may perform an LBT procedure prior to transmitting a feedback message during a PSFCH occasion 310. In such examples, if the LBT procedure fails, the destination UE may fail to transmit a feedback message. In such examples, the destination UE may transmit a multi-bit feedback message (e.g., during a subsequent PSFCH occasion 310) including feedback bits that the destination UE was previously unable to transmit (e.g., due to the failed LBT procedure), resulting in improved reliability of feedback signaling and more efficient use of available system resources.

In some examples, as described in greater detail with reference to FIGS. 4-9, the destination UE may generate the feedback bits and transmit the feedback message according to a codebook that supports multi-bit feedback messages. In some examples, such a codebook may be referred to as a type-1 HARQ-ACK codebook design.

FIG. 4 illustrates an example of a timeline 400 that supports HARQ codebooks for sidelink communications in accordance with one or more aspects of the present disclosure. Timeline 400 may be implemented by one or more wireless devices, which may be examples of corresponding devices described with reference to FIGS. 1-3. For instance, timeline 400 may be implemented by a transmitting sidelink UE (e.g., a UE 115-a) and a receiving sidelink UE (e.g., a UE 115-b). In some examples, one or more of the UEs may be in communication with a network entity (e.g., a network entity 105-a) via a communication link such as a Uu link. A UE that transmits a sidelink message (e.g., the UE 115-a) may be referred to a source UE. A UE that receives the sidelink message (e.g., and transmits a corresponding feedback message) may be referred to as a destination UE.

Described UEs may support type-1 HARQ-ACK codebook designs in sidelink communications (e.g., from a destination UE to a source UE). The destination UE may generate a feedback message (e.g., a HARQ message) based on one or more parameters or configurations. For instance, for a sidelink BWP on a serving cell c, and an active uplink BWP on the primary cell, a destination UE may determine a set of M_{A} candidate slots 405 (e.g., candidate slots for candidate PSSCH receptions) for which the destination UE may transmit corresponding HARQ-ACK information in a PSFCH occasion 410 during a slot n (e.g., which may be referred to as slot n_{PSFCH}) in a sidelink resource pool. The destination UE may determine the candidate slots associated with codebook 425 for a feedback message based on a set of sidelink resource pool bitmaps. For example, the bitmap may indicate the candidate slots 405 out of a set of contiguous slots (e.g., all slots) over a time period. The destination UE may determine the candidate slots 405 associated with codebook 425 for the feedback message based on a value of a time gap 420 (e.g., a minimum time gap, which may be referred to as Kₘᵢₙ) between a PSFCH occasion 410-b during which the feedback message is transmitted and the associated PSSCH for each sidelink resource pool (e.g., which may be provided by a network entity or preconfigured via a higher layer parameter, such as sl-MinTimeGapPSFCH). The destination UE may determine the candidate slots 405 associated with codebook 425 for the feedback message based on a value of period 415, where period 415 (e.g., which may be represented as P) which defines a period for periodic PSFCH occasions 410 for each sidelink resource pool (e.g., which may be provided by a network entity or preconfigured via high layer parameter, such as sl-PSFCH-Period).

The destination UE may use the resource pool configuration (e.g., a bitmap indicating which slots are allocated for sidelink communication) to determine whether a slot belongs to the sidelink resource pool or not. The destination UE may determine, for example, that slot n−7, slot n−6, slot n−5, slot n−4, slot n−3, slot n−2, slot n−1, and slot n, are all sidelink resources in the sidelink resource pool. Such slots may or may not be consecutive with one another in time. The destination UE may use the time gap 420 (e.g., between the PSFCH occasion 410-b in which the destination UE will transmit a feedback message and associated PSSCHs) to determine the set of slot timing values between candidate PSSCHs and the PSFCH occasion 410-b. The destination UE may determine whether a candidate slot includes a PSFCH occasion 410 (e.g., the PSFCH occasion 410-a, the PSFCH occasion 410-b, etc.) based on the period 415. Additionally, or alternatively, the destination UE may determine a number of feedback bits (e.g., HARQ-ACK bits) associated with each PSFCH occasion 410 based on the period 415. For example, where the period 415 equals four slots, the destination UE may generate four feedback bits (e.g., a multiple of the period 415, as described in greater detail with reference to FIG. 5).

Thus, the destination UE may determine that slot n is a sidelink slot based on the configuration information, and may further determine that PSFCH occasion 410-b is located in slot n. Where the time gap 420 is equal to two slots, and the period 415 is equal to four slots, the destination UE may determine to generate four feedback bits for a feedback message transmitted during PSFCH occasion 410-b. The destination UE may further generate the feedback message according to codebook 425, and may report feedback information for candidate slots n−Kₘᵢₙ (e.g., slot n−2) to n−Kₘᵢₙ−(P−1) (e.g., slot n−5). Thus, candidate slots may include slots n−5, n−4, n−3, and n−2. The feedback bits (e.g., HARQ-ACK information bits) may be ordered based on descending order of a timing gap or amount of time between a given candidate PSSCH to the slot in which the PSFCH occasion 410 is located. Thus, for PSFCH occasion 410-b located in slot n, the destination UE may order the feedback bits such that feedback bit J=0 associated with slot n−5 occurs first, feedback bit J=1 associated with slot n−4 occurs second, feedback bit J=2 associated with slot n=3 occurs third, and feedback bit J=3 associated with slot n−2 occurs fourth.

The destination UE may generate the feedback message for transmitting during PSFCH occasion 410-b according to codebook 425. The source UE may receive the feedback message and may decode the codebook 425. The source UE may determine whether a PSSCH transmission during slot n−5 was successfully received by the destination UE based on a first feedback bit J=0 (e.g., indicating ACK or NACK), may determine whether a PSSCH transmission during slot n−4 was successfully received by the destination UE based on a second ordered feedback bit J=1 (e.g., indicating ACK or NACK), may determine whether a PSSCH transmission during slot n−3 was successfully received by the destination UE based on a third feedback bit J=2 (e.g., indicating ACK or NACK), and may determine whether a PSSCH transmission during slot n−2 was successfully received by the destination UE based on a fourth feedback bit J=3 (e.g., indicating ACK or NACK).

In some examples, the destination UE may generate feedback bits based on a number of PSFCH occasions associated with a feedback message, which may result in multiple transmissions of each feedback bit (e.g., increasing reliability of feedback signaling in unlicensed spectrum), as described in greater detail with reference to FIG. 5.

FIG. 5 illustrates an example of a timeline 500 that supports HARQ codebooks for sidelink communications in accordance with one or more aspects of the present disclosure. Timeline 500 may be implemented by one or more wireless devices, which may be examples of corresponding devices described with reference to FIGS. 1-4. For instance, timeline 500 may be implemented by a transmitting sidelink UE (e.g., a UE 115-a) and a receiving sidelink UE (e.g., a UE 115-b). In some examples, one or more of the UEs may be in communication with a network entity (e.g., a network entity 105-a) via a communication link such as a Uu link. A UE that transmits a sidelink message (e.g., the UE 115-a) may be referred to a source UE. A UE that receives the sidelink message (e.g., and transmits a corresponding feedback message) may be referred to as a destination UE.

As described in greater detail with reference to FIG. 4, the destination UE may be configured or preconfigured with one or more parameters. For example, a network entity may configure the destination UE with a period 515 (e.g., P), a time gap 520 (e.g., Kₘᵢₙ), and an indication of a sidelink resource pool, from which the destination UE can identity sidelink slots and candidate slots 505 for a feedback message.

In some examples, the source UE and the destination UE may operate in a sidelink unlicensed band. In such examples, the destination UE may perform an LBT procedure prior to transmission of a feedback message on a PSFCH occasion 510 (e.g., such as PSFCH occasion 510-a, PSFCH occasion 510-b, PSFCH occasion 510-c, or PSFCH occasion 510-d). If the LBT procedure fails, then the destination UE may not be able to transmit a generated feedback message. Failed feedback signaling may result in inefficient PSSCH retransmissions. However, if feedback signaling (e.g., HARQ_ACK messages) can be retransmitted in a later PSFCH occasion 410, such inefficient PSSCH retransmission may be avoided, as described herein.

For a PSFCH occasion 510 in a slot n (e.g., slot n_{psfch}) in a sidelink resource pool, the destination UE may report feedback information (e.g., HARQ-ACK information) for candidate PSSCH reception occasions in slot n−Kₘᵢₙ to slot n−Kₘᵢₙ−(N×P−1)). where N may represent a number of PSFCH occasions 510 for the HARQ-ACK information associated with a PSFCH occasion 510 in which a feedback message is transmitted. In some examples, a value for N may be configured by a network entity (e.g., per resource pool), may be hardcoded or preconfigured at the destination UE, or may be included in one or more standards documents, among other examples. The destination UE may order feedback bits (HARQ-ACK information bits J) based on descending order of an amount of time or timing gap between candidate slots and the PSFCH occasion 510 in which the destination UE transmits the feedback message.

For example, a time gap 520 may be equal to two slots, and a period 515 may be equal to four slots. A value for N may be two. In such examples, for a feedback message transmitted in a PSFCH occasion 510, the feedback bits of the feedback message may be associated with N (e.g., two) PSFCH occasions 510. In such examples, the number of feedback bits in a codebook 425 may be equal to N×P (e.g., 2×4=8). For instance, for PSFCH occasion 510-c, the destination UE may generate codebook 425-a for transmitting a feedback message during slot n1. The feedback message based on codebook 425-a may include eight feedback bits, one for each of slot n−Kₘᵢₙ (e.g., slot n1−2) to slot n−Kₘᵢₙ−(N×P−1)) (e.g., slot n1−2−(2×4−1)), or slot n1−9). The destination UE may order feedback bits (e.g., feedback bit J=0 through feedback bit J=7) in descending order of amount of time between each candidate slot and slot n1 in which PSFCH occasion 510-c is located (e.g., feedback bit J=0 associated with slot n1−9 may be the first bit in the feedback message according to codebook 425-a, while feedback bit J=7 associated with slot n1−2 may be the last bit in the feedback message according to codebook 425-a).

Similarly, the destination UE may generate codebook 425-b for transmitting a second feedback message during PSFCH occasion 510-d during slot n2. The second feedback message based on codebook 425-b may include eight feedback bits, one for each of slot n−Kₘᵢₙ (e.g., slot n2-2) to slot n−Kₘᵢₙ−(N×P−1)) (e.g., slot n2−2−(2×4−1)), or slot n2−9). The destination UE may order feedback bits (e.g., feedback bit J=0 through feedback bit J=7) in descending order of amount of time between each candidate slot and slot n2 in which PSFCH occasion 510-d is located (e.g., feedback bit J=0 associated with slot n2−9 may be the first bit in the feedback message according to codebook 425-b, while feedback bit J=7 associated with slot n2−2 may be the last bit in the feedback message according to codebook 425-b).

Generating codebooks 425 associated with N PSFCH occasions 510 may improve the likelihood of successful reception by the source UE of the feedback bits. For example, the destination UE may perform an LBT procedure to gain access to unlicensed sidelink resources prior to transmitting the feedback message generated according to codebook 425-a during PSFCH occasion 510-c. However, if the LBT procedure fails, then the destination UE may not be able to transmit the feedback message during the PSFCH occasion 510-c. If the feedback bits prepared for transmission during PSFCH occasion 510-c are never transmitted, then the source UE may determine that one or more sidelink transmissions have failed, and may retransmit the sidelink messages. However, the destination UE may also generate the second feedback message according to codebook 425-b. Some of the feedback bits of codebook 425-b may be the same as at least some of the feedback bits of the codebook 425-a. For instance, bit J=4, bit J=5, bit J=6, and bit J=7 of codebook 425-a (e.g., corresponding, respectively, to slot n1−5, slot n1−4, slot n1−3, and slot n1−2) may correspond to the same slots as bit J=0, bit J=1, bit J=2, and bit J=3 of codebook 425-b (e.g., corresponding, respectively, to slot n2−5, slot n2−4, slot n2−3, and slot n2−2). Thus, some of the un-transmitted feedback bits of codebook 425-a may be transmitted at PSFCH occasion 510-d according to codebook 425-b. Similarly, remaining un-transmitted bits (e.g., bit J=0, bit J=1, bit J=2, and bit J=3 of codebook 425-a) may have been previously transmitted successfully (e.g., during PSFCH occasion 510-b). In such examples, despite failed LBT procedures associated with a PSFCH occasion 510, generated feedback bits may be successfully transmitted during previous or subsequent PSFCH occasions 510.

In some examples, a value of N may be configured or preconfigured by a network entity. For example, where LBT procedures regularly fail (e.g., higher channel occupancy) and feedback messages are not transmitted, the network entity may increase the value of N to cover more PSFCH occasions 510 and mitigate a higher number of failed LBT procedures. Where LBT procedures are more successful (e.g., lower channel occupancy), the network entity may decrease the value of N to cover less PSFCH occasions.

FIG. 6 illustrates an example of a timeline 600 that supports HARQ codebooks for sidelink communications in accordance with one or more aspects of the present disclosure. Timeline 600 may be implemented by one or more wireless devices, which may be examples of corresponding devices described with reference to FIGS. 1-5. For instance, timeline 600 may be implemented by a transmitting sidelink UE (e.g., a UE 115-a) and a receiving sidelink UE (e.g., a UE 115-b). In some examples, one or more of the UEs may be in communication with a network entity (e.g., a network entity 105-a) via a communication link such as a Uu link. A UE that transmits a sidelink message (e.g., the UE 115-a) may be referred to a source UE. A UE that receives the sidelink message (e.g., and transmits a corresponding feedback message) may be referred to as a destination UE.

As described in greater detail with reference to FIGS. 4-5, the destination UE may be configured with one or more parameters. For example, a network entity may configure the destination UE with a period 615 (e.g., P defining an amount of slots between PSFCH occasions 610, such as four slots between PSFCH occasion 610-a and PSFCH occasion 610-b), a time gap 620 (e.g., Kₘᵢₙ), and an indication of a sidelink resource pool, from which the destination UE can identify candidate slots 602 and slots associated with a feedback message.

A destination UE may generate one or more codebooks 625 for PSSCHs with different priority levels. For example, the source UE may transmit different sidelink messages during candidate slots 602. For example, the source UE may send a first priority level transmission 640-a during slot n−5 via PSSCH 605-a and during slot n−3 via PUSCH 605-c). The source UE may also send a second priority level transmission 640-b during slot n−4 via PSSCH 605-b.

In some examples, the UEs may support joint codebooks 630 (e.g., joint type-1 HARQ-ACK codebooks) for PSSCHs 605 associated with transmissions of different priority levels. In such examples, feedback bits (e.g., HARQ-ACK information bits) for PSSCHs 605 with different priority level transmissions may be transmitted in one HARQ-ACK codebook 625-a. Feedback bit location for the PSSCHs 605 may be determined based on the corresponding candidate PSSCH occasion index. In some examples, the source UE may order feedback bits in descending order of amount of time between a respective PSSCH 605 and the slot n in which the source UE transmits the feedback message (e.g., via the PSFCH occasion 610-b). Thus, for a time gap 620 of two slots, the destination UE may generate four bits, regardless of a priority level of transmissions received via respective PSSCHs 605. For instance, the destination UE may generate a first bit J=0 for the first priority level transmission 640-a received via PSSCH 605-a during slot n−5, may generate a second bit J=1 for a the second priority level transmission 640-b received via PSSCH 605-b during slot n−4, may generate a third bit J=2 for the first priority level transmission 640-a received via PSSCH 605-c during slot n−3, and may generate a fourth bit J=3 (e.g., a bit indicating a NACK based on a lack of a PSSCH 605 during slot n−2).

In some examples, UEs may support separate codebooks 635 (e.g., separate HARQ-ACK codebooks) for PSSCHs 605 associated with transmissions of different priority levels. In such examples, the destination UE may generate a first codebook 625-b for first priority level transmission 640-a and a second codebook 625-c for second priority level transmission 640-b. Feedback bit location for the PSSCHs 605 may be determined based on the corresponding candidate PSSCH occasion index. In some examples, the source UE may order feedback bits in descending order of amount of time between a respective PSSCH 605 and the slot n in which the source UE transmits the feedback message (e.g., via the PSFCH occasion 610-b). Thus, for a time gap 620 of two slots, the destination UE may generate four bits for each codebook 625. For instance, the destination UE may generate a first codebook 625-b for the first priority level transmission 640-a. The destination UE may generate a first bit J=0 for the first priority level transmission 640-a received via PSSCH 605-a during slot n−5, may generate a second bit J=1 (e.g., a NACK based on a lack of a first priority level transmission 640-a during slot n−4), may generate a third bit J=2 for the first priority level transmission 640-a received via PSSCH 605-c during slot n−3, and may generate a fourth bit J=3 (e.g., a bit indicating a NACK based on a lack of a PSSCH 605 during slot n−2). Similarly, the destination UE may generate a second codebook 625-c for the second priority level transmissions 640-b. The destination UE may generate a first bit J=0 (e.g., a NACK based on a lack of a second priority level transmission 640-b during slot n−5), may generate a second bit J=1 for the second priority level transmission 640-b received via PSSCH 605-b during slot n−4, may generate a third bit J=2 (e.g., a NACK based on a lack of a first priority level transmission 640-b during slot n−3), and may generate a fourth bit J=3 (e.g., a bit indicating a NACK based on a lack of a PSSCH 605 during slot n−2).

In some examples, a number of separate codebooks 625 for separate codebooks 635 may be hardcoded or configured (e.g., by a network entity via RRC signaling). For example, for a number N of codebooks 625 configured, a first codebook 625 may be associated with a first subset (e.g., 8/N) of priority level values, a second codebook 625 may be associated with a second subset (e.g., 8/N) of priority values, etc. For instance, a number of codebooks 625 may be configured (e.g., two codebooks 625), and each may be associated with a codebook index and a set of priority levels, as illustrated with reference to Table 1:

TABLE 1

| HARQ-ACK Codebook Index | Priority Level |
|---|---|
| 0 | 0-3 |
| 1 | 4-7 |

Thus, according to Table 1, the first codebook 625-b of the separate codebooks 635 may be associated with transmissions of priority levels 0-3, while second codebook 625-c of the separate codebooks 635 may be associated with transmissions of priority levels 4-7.

In some examples, a number of separate codebooks 625 for separate codebooks 635 may be based at least in part on an RRC parameter indicating a threshold priority level (e.g., sl-Priority Threshold or slPriorityThreshold-UL-URLLC). If such a parameter is configured by a network entity, then the destination UE may generate two codebooks 625, and a first codebook 625-b may be associated with a first set of PSSCH priority values (e.g., PSSCH priority values that are less than a threshold priority level) and a second codebook 625-b may be associated with a second set of PSSCH priority values (e.g., PSSCH priority values that are equal to or greater than the threshold priority level). Such codebook generation mechanisms are illustrated with reference to Table 2:

TABLE 2

| HARQ-ACK Codebook Index | Priority Level |
|---|---|
| 0 | Priority Level < Threshold |
| 1 | Priority Level ≥ Threshold |

If the destination UE is not configured with the threshold priority level, the destination UE may default to a single, joint codebook 630.

In some examples, the destination UE may determine whether to generate a joint codebook 630 or separate codebooks 635 based on instructions received from a network entity. For example, the destination UE may receive RRC signaling indicating that the destination UE is to generate a joint codebook 630 or separate codebooks 635. In such examples, the destination UE may generate codebooks 625 according to the RRC signaling, and may transmit feedback messages according to the generated codebook 625 or codebooks 625.

FIG. 7 illustrates an example of a feedback weighting scheme 700 that supports HARQ codebooks for sidelink communications in accordance with one or more aspects of the present disclosure. Feedback weighting scheme 700 may implement aspects of, or be implemented by aspects of, wireless communications system 100 or wireless communications system 200, timeline 300, timeline 400, timeline 500, or timeline 600. Feedback weighting scheme 700 may be implemented by one or more wireless devices, which may be examples of corresponding devices described with reference to FIGS. 1-6. For instance, feedback weighting scheme 700 may be implemented by a transmitting sidelink UE (e.g., a UE 115-a) and a receiving sidelink UE (e.g., a UE 115-b). In some examples, one or more of the UEs may be in communication with a network entity (e.g., a network entity 105-a) via a communication link such as a Uu link. A UE that transmits a sidelink message (e.g., the UE 115-a) may be referred to a source UE. A UE that receives the sidelink message (e.g., and transmits a corresponding feedback message) may be referred to as a destination UE.

In some examples, the destination UE may prepare to transmit multiple PSFCH transmissions in a single PSFCH occasion. In such examples, the destination may not be able to transmit at least one of the multiple PSFCH transmissions due to one or more reasons. For instance, the destination UE may detect or predict collisions, or a number of generated PSFCH transmissions may exceed capability of the UE, or the transmission power at the destination UE may be limited, among other examples. In such examples, the destination UE may drop one or more PSFCH transmissions based on a priority level of the PSFCH transmission. For PSFCHs carrying codebooks (e.g., type-1 HARQ-ACK codebooks, as described with reference to FIGS. 2-6), the destination UE, some of the feedback information may include pending bits. When determining a priority level for such PSFCH transmissions, valid ACK/NACK bits may be considered for more efficient selection of which PSFCH transmissions to drop, and which to transmit.

In some examples, a destination UE may determine a priority level for different PSFCH transmissions with multi-bit ACK-NACK codebooks based on a number of valid feedback bits (e.g., valid ACK/NACK bits) and a priority of each valid ACK/NACK bit. The destination UE may determine the priority value of each PSFCH as Σₘ₌₀^{M-1}wₘ×pₘ, where M represents a number of valid feedback bits, wₘ represents a weight for an m-th valid feedback bit, and pₘ represents a priority value associated with the m-th valid feedback bit. Then, a weight wₘ can be an average weight across all valid feedback bits

$$( e . g . , where {w}_{m} = \frac{1}{M} ) .$$

In some examples, lower priority values may indicate higher priority levels.

For instance, for PSFCH 1, the destination UE may generate a codebook 705. The codebook 705 may include four feedback bits. Codebook 705 may include M=3 valid feedback bits (e.g., the first three feedback bits of the codebook), where the fourth bit of the codebook may be a NACK due to a lack of a PSSCH during a fourth slot, or due to a lack of a transmission having a qualifying priority level (e.g., as described with reference to FIG. 6). That is, a valid feedback bit may refer to a feedback bit that indicates whether a sidelink message was or was not successfully received during a PSSCH (e.g., as opposed to a NACK for a slot in which no PSSCH is received). In some examples, a first valid feedback bit of codebook 705 may be associated with a priority level of p=0, a second valid feedback bit of the codebook 705 may be associated with a priority level of p=2, and a third valid feedback bit of the codebook 705 may be associated with a priority level of p=0. Thus, for the three valid feedback bits, the average weighted priority value for the PSFCH 1 maybe ⅔. The destination UE may also generate a codebook 710. The codebook 710 may include four feedback bits, may be include M=1 valid feedback bit. For instance, the second feedback bit may be a valid feedback bit, indicating an ACK or NACK for a PSSCH, while the first, third, and fourth bit of the codebook 710 may not be valid feedback bits (e.g., may be associated with slots in which no PSSCH is scheduled). The second feedback bit may have a priority level of p=1. In such examples, for the one valid feedback bit, the average weighted priority value for the PSFCH 2 may be 1. In such examples, PSFCH 1 may have a higher priority than PSFCH 2 (e.g., because ⅔<1). Thus, by determine an average weighted value across all valid feedback bits of a codebook, the destination UE may determine which codebook (e.g., which PSFCH) has a higher priority level (e.g., a lower priority value). In such examples, the destination UE may drop the PSFCH transmission having the lower priority level (e.g., the higher priority value). For instance, the destination UE may drop PSFCH 2, and may transmit PSFCH 1 according to codebook 705.

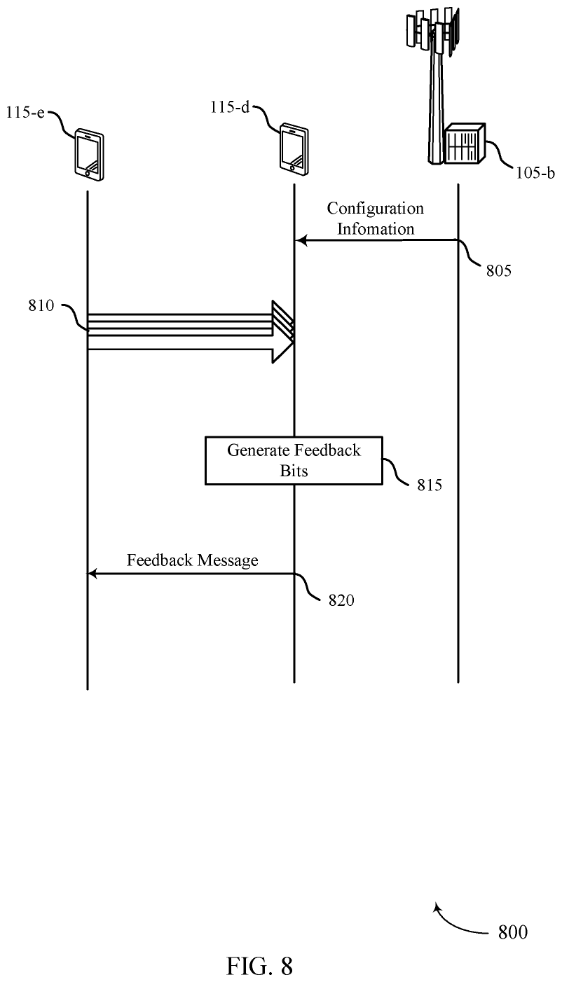

FIG. 8 illustrates an example of a process flow 800 that supports HARQ codebooks for sidelink communications in accordance with one or more aspects of the present disclosure. Process flow 800 may include a network entity 105-b, a UE 115-d, and a UE 115-e, which may be examples of corresponding devices (e.g., UE 115-a and UE 115-b, and network entity 105-a) described with reference to FIGS. 1-7.

At 805, the UE 115-d may receive (e.g., from a network entity 105-b) configuration information. For example, the UE 115-d may receive an indicator of a configuration of a sidelink resource pool (e.g., a bitmap indicating logical slots for sidelink communications), a time gap (e.g., Kₘᵢₙ) indicating a first number of slots for generating feedback information for one or more slots of the sidelink resource pool, and a periodicity (e.g., P) of a set of feedback occasions (e.g., PSFCH occasions) within the sidelink pool.

At 810, the UE 115-e may transmit, to the UE 115-d, one or more sidelink messages (e.g., multiple sidelink messages on PSSCHs in one or more of the multiple slots).

At 815, the UE 115-d may generate multiple feedback bits corresponding to a set of candidate slots of the multiple slots of the sidelink resource pool. In some examples, the UE 115-d may order the feedback bits of the feedback message in according to a descending order of number of slots between each candidate slot of the set of candidate slots and the first slot, wherein each feedback bit of the plurality of feedback bits is associated with a respective candidate slot of the set of candidate slots.

In some examples, the UE 115-d may generate the feedback bits associated with the candidate slots corresponding to a first priority level or a second priority level where the first portion level may be higher than the second priority level (e.g., a joint codebook, as described in greater detail with reference to FIG. 6). In some examples, the UE 115-d may receive an indication of a second configuration (e.g., at 805 in a same message as the first configuration, or in a separate message, such as an RRC message) indicating that the UE 115-d is to generate one set of feedback bits for the first priority level and the second priority level (e.g., a joint codebook).

In some examples, the UE 115-d may generate a first set of feedback bits associated with transmissions corresponding to a first priority level received over the set of candidate slots, and may generate a second set of feedback bits associated with transmissions corresponding to a second priority level received over a second set of candidate slots (e.g., separate codebooks, as described in greater detail with reference to FIG. 6). The first priority level may be higher than the second priority level. In some examples, the UE 115-d may receive an indication of a third configuration (e.g., at 805 in a same message as the first configuration, or in a separate message, such as an RRC message) indicating that the UE 115-d is to generate separate sets of feedback bits for the first priority level and the second priority level, respectively (e.g., separate codebooks). In some examples, the network entity 105-b (e.g., in a same message as the configuration information transmitted at 805 or in a separate message, such as an RRC message) may transmit a number of priority levels, and the UE 115-d may generate separate codebooks for each of the number of indicated priority levels. In some examples, the network entity may provide (e.g., via RRC signaling at 805 or separate from the signaling at 805) an indicator of a threshold priority level. In such examples, the UE 115-d may determine that a first priority level satisfies the threshold priority level and a second priority level does not satisfy the threshold priority level, and may generate the separate codebooks based on the different priority levels satisfying or not satisfying the threshold level, as described in greater detail with reference to FIG. 6.

At 820, the UE 115-d may transmit a feedback message to the UE 115-e. The feedback message may include one or more indicators of the multiple feedback bits. The UE 115-d may transmit the feedback message according to a generated codebook (e.g., a HARQ-ACK codebook) during a first feedback occasion of the set of feedback occasions in a first slot.

In some examples, as described in greater detail with reference to the FIGS. 2-6, the set of candidate slots may include one or more slots located between a first candidate slot occurring at the first number of slots (e.g., the time gap) before the first slot, and a second candidate slot occurring at a second number of slots before the first slot. In some examples, the second number of slots may be equal to one slot less than a sum of the first number of slots and the periodicity of the set of feedback occasions (e.g., n−Kₘᵢₙ to n−Kₘᵢₙ−(P−1)) as described in greater detail with reference to FIG. 4. In some examples, the second number of slots may be equal to one slot less than a product of the periodicity of the set of feedback occasions and a number of feedback occasions N associated with the feedback occasion of the set of feedback occasions (e.g., n−Kₘᵢₙ to n−Kₘᵢₙ−(N×P−1), as described in greater detail with reference to FIG. 5). In some examples, the number of feedback occasions (e.g., N) may be configured by the base station via RRC signaling (e.g., in a same messages as the configuration information received at 805, or in a different RRC message). In some examples, the number of feedback occasions (e.g., N) may be preconfigured, predefined, hardcoded, included in one or more standards documents, or the like.

In some examples, prior to transmitting the feedback message at 820, the UE 115-d may perform an LBT procedure to gain access to unlicensed sidelink resources.

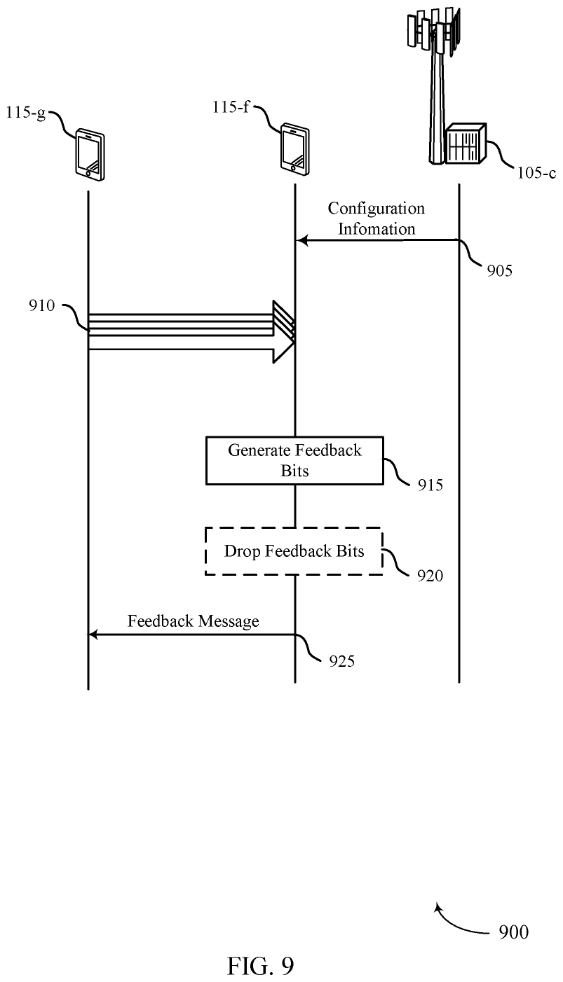

FIG. 9 illustrates an example of a process flow 900 that supports HARQ codebooks for sidelink communications in accordance with one or more aspects of the present disclosure. Process flow 900 may include a network entity 105-c, a UE 115-f, and a UE 115-g, which may be examples of corresponding devices (e.g., UE 115-a and UE 115-b, and network entity 105-a) described with reference to FIGS. 1-8.

At 905, the UE 115-f may receive (e.g., from a network entity 105-c) configuration information. For example, the UE 115-f may receive an indicator of a configuration of a sidelink resource pool (e.g., a bitmap indicating logical slots for sidelink communications), a time gap (e.g., Kₘᵢₙ) indicating a first number of slots for generating feedback information for one or more slots of the sidelink resource pool, and a periodicity (e.g., P) of a set of feedback occasions (e.g., PSFCH occasions) within the sidelink pool.

At 910, the UE 115-g may transmit, to the UE 115-e, one or more sidelink messages (e.g., multiple sidelink messages on PSSCHs in one or more of the multiple slots).

At 915, the UE 115-d may generate, for a first feedback occasion of the set of periodic feedback occasions, multiple feedback bits corresponding to a set of candidate slots of the multiple slots of the sidelink resource pool. In some examples, the UE 115-d may order the feedback bits of the feedback message in according to a descending order of number of slots between each candidate slot of the set of candidate slots and the first slot, wherein each feedback bit of the plurality of feedback bits is associated with a respective candidate slot of the set of candidate slots.

In some examples, the UE 115-f may generate a first set of feedback bits corresponding to a first set of candidate slots (e.g., a first codebook for a first PSFCH) and a second set of feedback bits corresponding to a second set of candidate slots (e.g., a second codebook for a second PSFCH), as described in greater detail with reference to FIG. 7.

At 920, the UE 115-f may drop some of the generated feedback bits (e.g., may drop one of the codebooks or PSFCHs that occur during a same slot). The UE 115-f may drop the feedback bits based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots. For example, the UE 115-f may determine a first average weight value for the first set of candidate slots based at least in part on the first priority level and the number of detected transmissions associated with the first set of candidate slots, and may further determine a second average weight value for the second set of candidate slots based at least in part on the second priority level and the number of detected transmissions associated with the second set of candidate slots (e.g., as described in greater detail with reference to FIG. 7). In such examples, the UE 115-f may refrain from transmitting (e.g., drop) the second set of feedback bits during the first feedback occasion based on the first average weight and the second average weight (e.g., may drop the feedback bits associated with the higher average weight value and the lower priority level).

In some examples, the UE 115-f may drop the second set of feedback bits based on identifying a collision between the first set of feedback bits and the second set of feedback bits during the first feedback occasion. In some examples, the UE 115-f may drop the second set of feedback bits based on determining a quantity of feedback messages for transmission in the first feedback occasion, or a capability associated with a number of simultaneously feedback transmissions supported by the UE 115-f, or a combination thereof. For example, the UE 115-f may determine whether the quantity of feedback messages for transmission in the first feedback occasion exceeds a threshold (e.g., associated with the capability of the UE 115-f.

At 925, the UE 115-f may transmit the first set of feedback bits during the first feedback occasion. The UE 115-f may transmit the first set of feedback bits based on the first priority level for transmissions received over the first set of candidate slots, the second priority level for transmissions received over the second set of candidate slots, the number of detected transmissions associated with the first set of candidate slots, and the number of detected transmissions associated with the second set of candidate slots (e.g., based on having dropped the second set of feedback bits at 920).

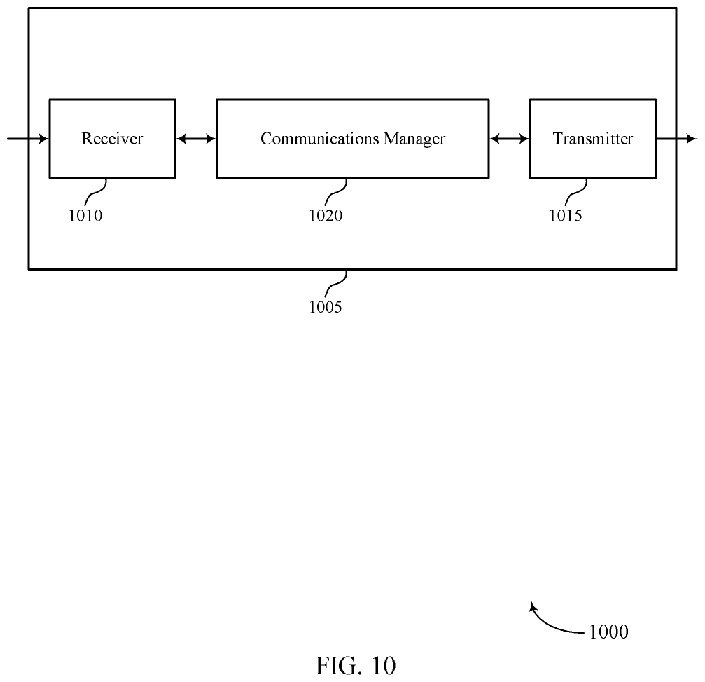

FIG. 10 shows a block diagram 1000 of a device 1005 that supports HARQ codebooks for sidelink communications in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to HARQ codebooks for sidelink communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to HARQ codebooks for sidelink communications). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of HARQ codebooks for sidelink communications as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first wireless device in accordance with examples as disclosed herein. For example, the communications manager 1020 may be configured as or otherwise support a means for receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool. The communications manager 1020 may be configured as or otherwise support a means for generating a set of multiple feedback bits corresponding to a set of candidate slots of the set of multiple slots based on the time gap and the periodicity of the set of feedback occasions. The communications manager 1020 may be configured as or otherwise support a means for transmitting a feedback message including one or more indicators of the set of multiple feedback bits on a feedback occasion of the set of feedback occasions that is located within a first slot of the sidelink resource pool.

Additionally, or alternatively, the communications manager 1020 may support wireless communications at a wireless device in accordance with examples as disclosed herein. For example, the communications manager 1020 may be configured as or otherwise support a means for receiving an indicator of a configuration of a sidelink resource pool including a set of multiple slots allocated for sidelink communication, the sidelink resource pool including a set of periodic feedback occasions. The communications manager 1020 may be configured as or otherwise support a means for generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots. The communications manager 1020 may be configured as or otherwise support a means for transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for sidelink feedback signaling, resulting in improved reliability of communication, more efficient use of system resources, decreased system latency, and improved user experience.

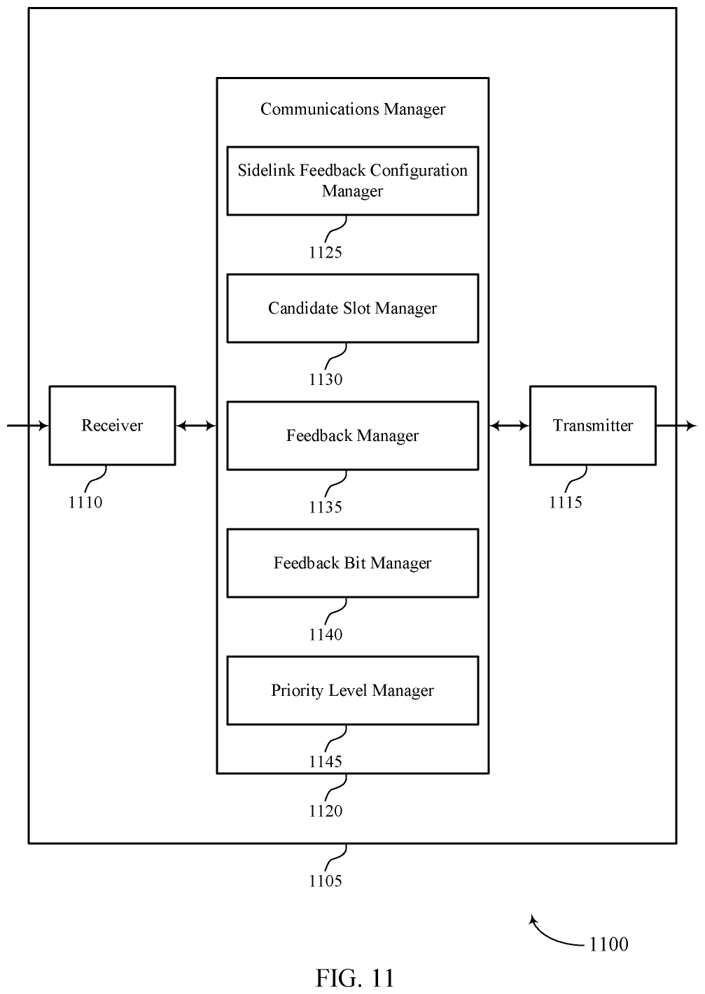

FIG. 11 shows a block diagram 1100 of a device 1105 that supports HARQ codebooks for sidelink communications in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to HARQ codebooks for sidelink communications). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to HARQ codebooks for sidelink communications). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of HARQ codebooks for sidelink communications as described herein. For example, the communications manager 1120 may include a sidelink feedback configuration manager 1125, a candidate slot manager 1130, a feedback manager 1135, a feedback bit manager 1140, a priority level manager 1145, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a first wireless device in accordance with examples as disclosed herein. The sidelink feedback configuration manager 1125 may be configured as or otherwise support a means for receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool. The candidate slot manager 1130 may be configured as or otherwise support a means for generating a set of multiple feedback bits corresponding to a set of candidate slots of the set of multiple slots based on the time gap and the periodicity of the set of feedback occasions. The feedback manager 1135 may be configured as or otherwise support a means for transmitting a feedback message including one or more indicators of the set of multiple feedback bits on a feedback occasion of the set of feedback occasions that is located within a first slot of the sidelink resource pool.

Additionally, or alternatively, the communications manager 1120 may support wireless communications at a wireless device in accordance with examples as disclosed herein. The sidelink feedback configuration manager 1125 may be configured as or otherwise support a means for receiving an indicator of a configuration of a sidelink resource pool including a set of multiple slots allocated for sidelink communication, the sidelink resource pool including a set of periodic feedback occasions. The feedback bit manager 1140 may be configured as or otherwise support a means for generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots. The priority level manager 1145 may be configured as or otherwise support a means for transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

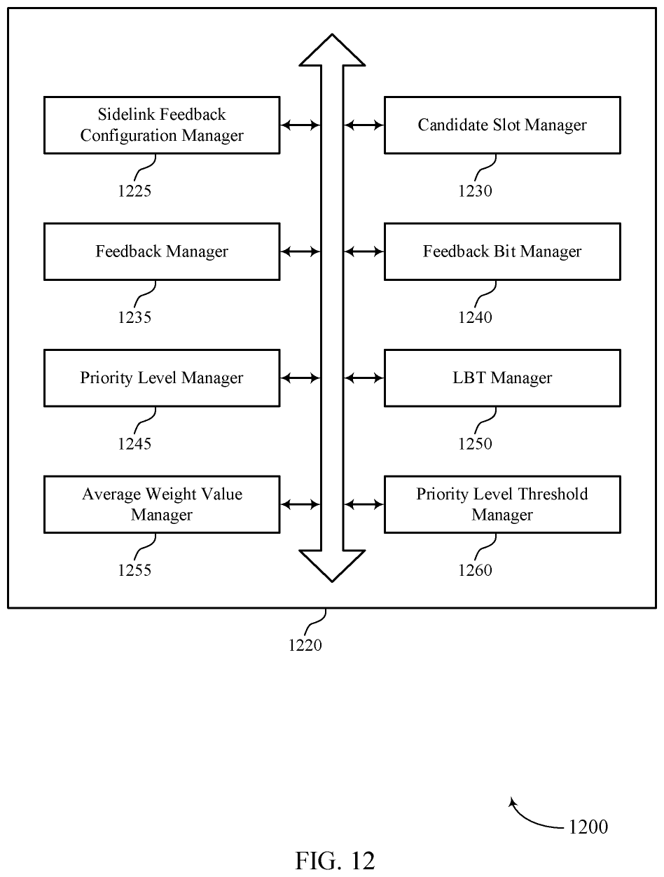

FIG. 12 shows a block diagram 1200 of a communications manager 1220 that supports HARQ codebooks for sidelink communications in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of HARQ codebooks for sidelink communications as described herein. For example, the communications manager 1220 may include a sidelink feedback configuration manager 1225, a candidate slot manager 1230, a feedback manager 1235, a feedback bit manager 1240, a priority level manager 1245, an LBT manager 1250, an average weight value manager 1255, a priority level threshold manager 1260, or any combination thereof. Each of these components may communicate, directly or indirectly, with one another (e.g., via one or more buses).

The communications manager 1220 may support wireless communications at a first wireless device in accordance with examples as disclosed herein. The sidelink feedback configuration manager 1225 may be configured as or otherwise support a means for receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool. The candidate slot manager 1230 may be configured as or otherwise support a means for generating a set of multiple feedback bits corresponding to a set of candidate slots of the set of multiple slots based on the time gap and the periodicity of the set of feedback occasions. The feedback manager 1235 may be configured as or otherwise support a means for transmitting a feedback message including one or more indicators of the set of multiple feedback bits on a feedback occasion of the set of feedback occasions that is located within a first slot of the sidelink resource pool.

In some examples, the set of candidate slots of the set of multiple slots includes one or more slots located between a first candidate slot occurring at the first number of slots before the first slot and a second candidate slot occurring at a second number of slots before the first slot. In some examples, the second number of slots is equal to one slot less than a sum of the first number of slots and the periodicity of the set of feedback occasions.

In some examples, the second number of slots is equal to one slot less than a product of the periodicity of the set of feedback occasions and a number of feedback occasions associated with the feedback occasion of the set of feedback occasions.

In some examples, to support receiving the indication of the configuration, the sidelink feedback configuration manager 1225 may be configured as or otherwise support a means for receiving a radio resource control message indicating the number of feedback occasions. In some examples, the number of feedback occasions is predefined.

In some examples, the feedback bit manager 1240 may be configured as or otherwise support a means for ordering the one or more indicators of the set of multiple feedback bits in the feedback message according to a descending order of number of slots between each candidate slot of the set of candidate slots and the first slot, where each feedback bit of the set of multiple feedback bits is associated with a respective candidate slot of the set of candidate slots.

In some examples, the LBT manager 1250 may be configured as or otherwise support a means for performing a listen-before-talk procedure, where the sidelink resource pool includes unlicensed spectrum, and where transmitting the feedback message is based on determining that the listen-before-talk procedure is successful.

In some examples, to support generating the set of multiple feedback bits, the feedback bit manager 1240 may be configured as or otherwise support a means for generating the set of multiple feedback bits associated with the set of candidate slots corresponding to a first priority level or a second priority level, where the first priority level is higher than the second priority level.

In some examples, the sidelink feedback configuration manager 1225 may be configured as or otherwise support a means for receiving an indication of a second configuration to generate one set of multiple feedback bits for the first priority level and the second priority level, where generating the set of multiple feedback bits is based on the second configuration.

In some examples, to support generating the set of multiple feedback bits, the feedback bit manager 1240 may be configured as or otherwise support a means for generating the set of multiple feedback bits associated with transmissions corresponding to a first priority level received over the set of candidate slots. In some examples, to support generating the set of multiple feedback bits, the feedback bit manager 1240 may be configured as or otherwise support a means for generating a second set of multiple feedback bits associated with transmissions corresponding to a second priority level received over a second set of candidate slots, where the first priority level is higher than the second priority level.

In some examples, the priority level manager 1245 may be configured as or otherwise support a means for receiving an indicator of a number of priority levels including the first priority level and the second priority level, where generating the set of multiple feedback bits and generating the second set of multiple feedback bits are based on the indicator of the number of priority levels.

In some examples, the priority level threshold manager 1260 may be configured as or otherwise support a means for receiving an indicator of a threshold priority level. In some examples, the priority level threshold manager 1260 may be configured as or otherwise support a means for determining that the first priority level satisfies the threshold priority level and that the second priority level does not satisfy the threshold priority level, where generating the set of multiple feedback bits and generating the second set of multiple feedback bits are based on the determining.

In some examples, the priority level threshold manager 1260 may be configured as or otherwise support a means for receiving an indication of a third configuration to generate the set of multiple feedback bits and the second set of multiple feedback bits corresponding to respective priority levels of a set of multiple priority levels including the first priority level and the second priority level, where generating the set of multiple feedback bits and generating the second set of multiple feedback bits is based on the third configuration.

Additionally, or alternatively, the communications manager 1220 may support wireless communications at a wireless device in accordance with examples as disclosed herein. In some examples, the sidelink feedback configuration manager 1225 may be configured as or otherwise support a means for receiving an indicator of a configuration of a sidelink resource pool including a set of multiple slots allocated for sidelink communication, the sidelink resource pool including a set of periodic feedback occasions. The feedback bit manager 1240 may be configured as or otherwise support a means for generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots. The priority level manager 1245 may be configured as or otherwise support a means for transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

In some examples, the average weight value manager 1255 may be configured as or otherwise support a means for determining a first average weight value for the first set of candidate slots based on the first priority level and the number of detected transmissions associated with the first set of candidate slots and a second average weight value for the second set of candidate slots based on the second priority level and the number of detected transmissions associated with the second set of candidate slots.

In some examples, the average weight value manager 1255 may be configured as or otherwise support a means for refraining from transmitting the second set of multiple feedback bits during the first feedback occasion based on the first average weight value and the second average weight value.

In some examples, the average weight value manager 1255 may be configured as or otherwise support a means for identifying a collision between the first set of multiple feedback bits and the second set of multiple feedback bits during the first feedback occasion. In some examples, the sidelink feedback configuration manager 1225 may be configured as or otherwise support a means for determining the first average weight value and the second average weight value based on identifying the collision.

In some examples, the average weight value manager 1255 may be configured as or otherwise support a means for determining a quantity of feedback messages for transmission in the first feedback occasion. In some examples, the average weight value manager 1255 may be configured as or otherwise support a means for determining the first average weight value and the second average weight value based on determining that the quantity of feedback messages exceeds a threshold. In some examples, the first priority level is higher than the second priority level.

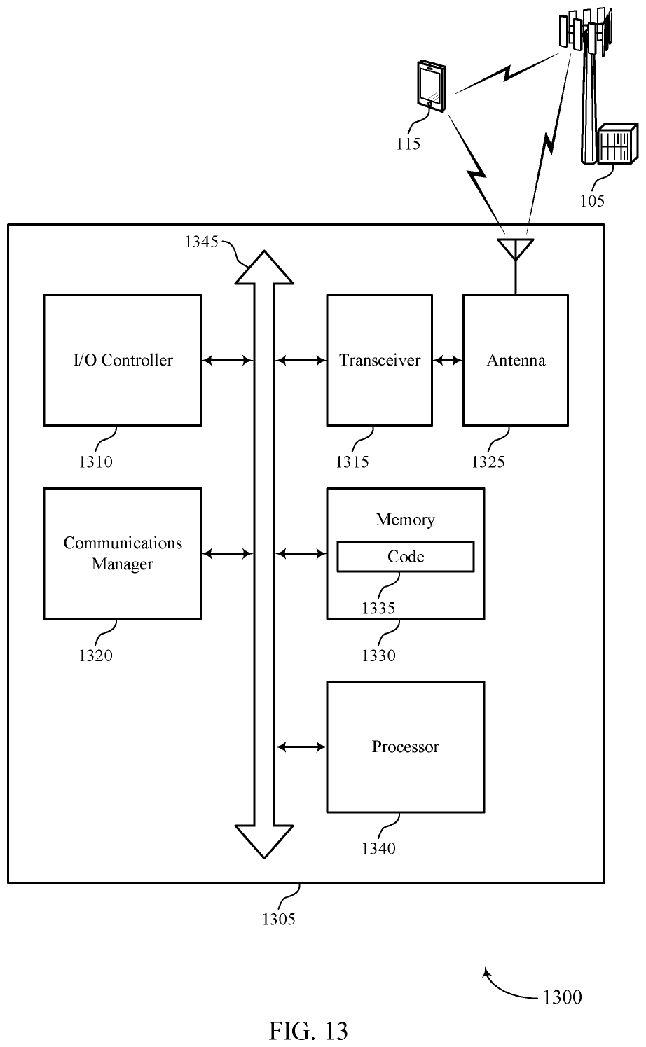

FIG. 13 shows a diagram of a system 1300 including a device 1305 that supports HARQ codebooks for sidelink communications in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting HARQ codebooks for sidelink communications). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communications at a first wireless device in accordance with examples as disclosed herein. For example, the communications manager 1320 may be configured as or otherwise support a means for receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool. The communications manager 1320 may be configured as or otherwise support a means for generating a set of multiple feedback bits corresponding to a set of candidate slots of the set of multiple slots based on the time gap and the periodicity of the set of feedback occasions. The communications manager 1320 may be configured as or otherwise support a means for transmitting a feedback message including one or more indicators of the set of multiple feedback bits on a feedback occasion of the set of feedback occasions that is located within a first slot of the sidelink resource pool.

Additionally, or alternatively, the communications manager 1320 may support wireless communications at a wireless device in accordance with examples as disclosed herein. For example, the communications manager 1320 may be configured as or otherwise support a means for receiving an indicator of a configuration of a sidelink resource pool including a set of multiple slots allocated for sidelink communication, the sidelink resource pool including a set of periodic feedback occasions. The communications manager 1320 may be configured as or otherwise support a means for generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots. The communications manager 1320 may be configured as or otherwise support a means for transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

By including or configuring the communications manager 1320 in accordance with examples as described herein, the device 1305 may support techniques for sidelink feedback signaling, resulting in improved reliability of communication, more efficient use of system resources, decreased system latency, and improved user experience.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of HARQ codebooks for sidelink communications as described herein, or the processor 1340 and the memory 1330 may be otherwise configured to perform or support such operations.

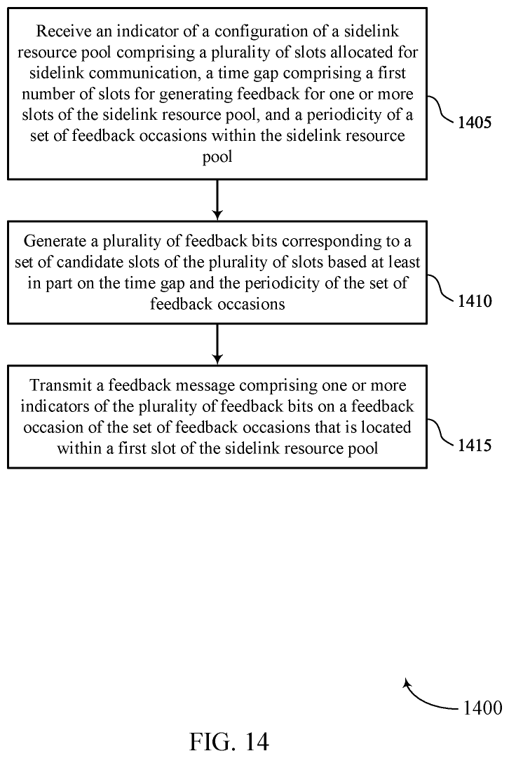

FIG. 14 shows a flowchart illustrating a method 1400 that supports HARQ codebooks for sidelink communications in accordance with one or more aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool. The operations of 1405 may be performed in accordance with examples as disclosed herein. In some examples, aspects of the operations of 1405 may be performed by a sidelink feedback configuration manager 1225 as described with reference to FIG. 12.

At 1410, the method may include generating a set of multiple feedback bits corresponding to a set of candidate slots of the set of multiple slots based on the time gap and the periodicity of the set of feedback occasions. The operations of 1410 may be performed in accordance with examples as disclosed herein. In some examples, aspects of the operations of 1410 may be performed by a candidate slot manager 1230 as described with reference to FIG. 12.

At 1415, the method may include transmitting a feedback message including one or more indicators of the set of multiple feedback bits on a feedback occasion of the set of feedback occasions that is located within a first slot of the sidelink resource pool. The operations of 1415 may be performed in accordance with examples as disclosed herein. In some examples, aspects of the operations of 1415 may be performed by a feedback manager 1235 as described with reference to FIG. 12.

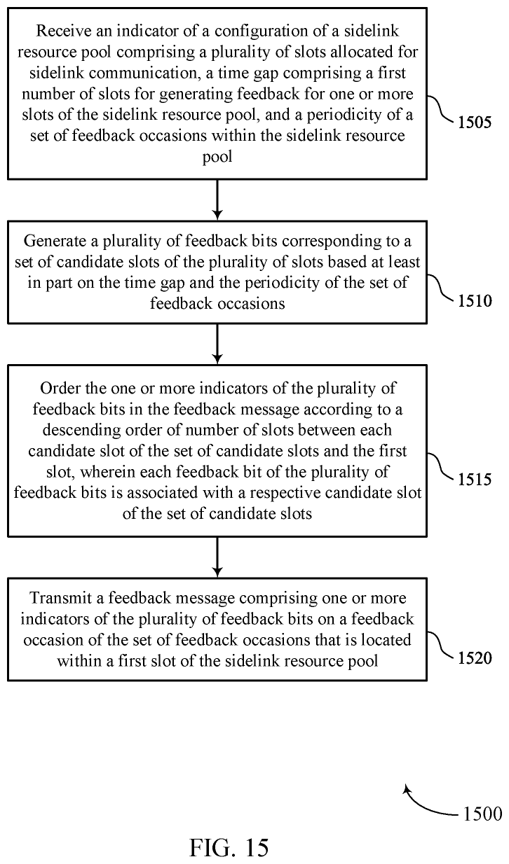

FIG. 15 shows a flowchart illustrating a method 1500 that supports HARQ codebooks for sidelink communications in accordance with one or more aspects of the present disclosure. The operations of the method 1500 may be implemented by a UE or its components as described herein. For example, the operations of the method 1500 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1505, the method may include receiving an indicator of a configuration of a sidelink resource pool including a set of multiple slots allocated for sidelink communication, a time gap including a first number of slots for generating feedback for one or more slots of the sidelink resource pool, and a periodicity of a set of feedback occasions within the sidelink resource pool. The operations of 1505 may be performed in accordance with examples as disclosed herein. In some examples, aspects of the operations of 1505 may be performed by a sidelink feedback configuration manager 1225 as described with reference to FIG. 12.

At 1510, the method may include generating a set of multiple feedback bits corresponding to a set of candidate slots of the set of multiple slots based on the time gap and the periodicity of the set of feedback occasions. The operations of 1510 may be performed in accordance with examples as disclosed herein. In some examples, aspects of the operations of 1510 may be performed by a candidate slot manager 1230 as described with reference to FIG. 12.

At 1515, the method may include ordering the one or more indicators of the set of multiple feedback bits in the feedback message according to a descending order of number of slots between each candidate slot of the set of candidate slots and the first slot, where each feedback bit of the set of multiple feedback bits is associated with a respective candidate slot of the set of candidate slots. The operations of 1515 may be performed in accordance with examples as disclosed herein. In some examples, aspects of the operations of 1515 may be performed by a feedback bit manager 1240 as described with reference to FIG. 12.

At 1520, the method may include transmitting a feedback message including one or more indicators of the set of multiple feedback bits on a feedback occasion of the set of feedback occasions that is located within a first slot of the sidelink resource pool. The operations of 1520 may be performed in accordance with examples as disclosed herein. In some examples, aspects of the operations of 1520 may be performed by a feedback manager 1235 as described with reference to FIG. 12.

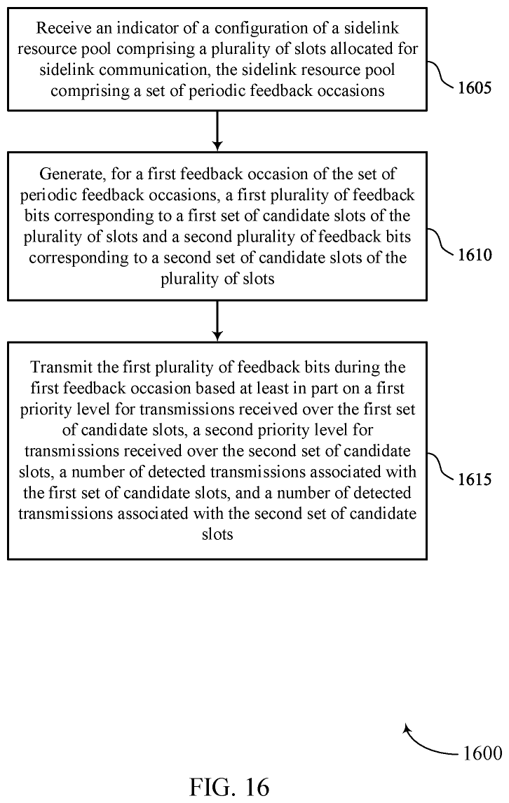

FIG. 16 shows a flowchart illustrating a method 1600 that supports HARQ codebooks for sidelink communications in accordance with one or more aspects of the present disclosure. The operations of the method 1600 may be implemented by a UE or its components as described herein. For example, the operations of the method 1600 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1605, the method may include receiving an indicator of a configuration of a sidelink resource pool including a set of multiple slots allocated for sidelink communication, the sidelink resource pool including a set of periodic feedback occasions. The operations of 1605 may be performed in accordance with examples as disclosed herein. In some examples, aspects of the operations of 1605 may be performed by a sidelink feedback configuration manager 1225 as described with reference to FIG. 12.

At 1610, the method may include generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots. The operations of 1610 may be performed in accordance with examples as disclosed herein. In some examples, aspects of the operations of 1610 may be performed by a feedback bit manager 1240 as described with reference to FIG. 12.

At 1615, the method may include transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots. The operations of 1615 may be performed in accordance with examples as disclosed herein. In some examples, aspects of the operations of 1615 may be performed by a priority level manager 1245 as described with reference to FIG. 12.

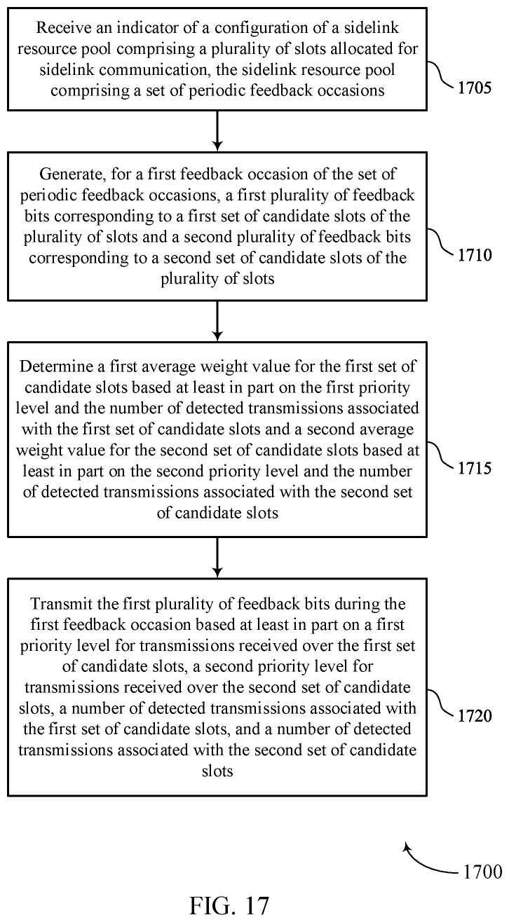

FIG. 17 shows a flowchart illustrating a method 1700 that supports HARQ codebooks for sidelink communications in accordance with one or more aspects of the present disclosure. The operations of the method 1700 may be implemented by a UE or its components as described herein. For example, the operations of the method 1700 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1705, the method may include receiving an indicator of a configuration of a sidelink resource pool including a set of multiple slots allocated for sidelink communication, the sidelink resource pool including a set of periodic feedback occasions. The operations of 1705 may be performed in accordance with examples as disclosed herein. In some examples, aspects of the operations of 1705 may be performed by a sidelink feedback configuration manager 1225 as described with reference to FIG. 12.

At 1710, the method may include generating, for a first feedback occasion of the set of periodic feedback occasions, a first set of multiple feedback bits corresponding to a first set of candidate slots of the set of multiple slots and a second set of multiple feedback bits corresponding to a second set of candidate slots of the set of multiple slots. The operations of 1710 may be performed in accordance with examples as disclosed herein. In some examples, aspects of the operations of 1710 may be performed by a feedback bit manager 1240 as described with reference to FIG. 12.

At 1715, the method may include determining a first average weight value for the first set of candidate slots based on the first priority level and the number of detected transmissions associated with the first set of candidate slots and a second average weight value for the second set of candidate slots based on the second priority level and the number of detected transmissions associated with the second set of candidate slots. The operations of 1715 may be performed in accordance with examples as disclosed herein. In some examples, aspects of the operations of 1715 may be performed by an average weight value manager 1255 as described with reference to FIG. 12.

At 1720, the method may include transmitting the first set of multiple feedback bits during the first feedback occasion based on a first priority level for transmissions received over the first set of candidate slots, a second priority level for transmissions received over the second set of candidate slots, a number of detected transmissions associated with the first set of candidate slots, and a number of detected transmissions associated with the second set of candidate slots. The operations of 1720 may be performed in accordance with examples as disclosed herein. In some examples, aspects of the operations of 1720 may be performed by a priority level manager 1245 as described with reference to FIG. 12.

The following provides an overview of aspects of the present disclosure:

Aspect 1: A method for wireless communications at a first wireless device, comprising: receiving an indicator of a configuration of a sidelink resource pool comprising a plurality of slots allocated for sidelink communication, a time gap comprising a first number of slots for generating feedback for one or more slots of the sidelink resource pool, and a periodicity of a set of feedback occasions within the sidelink resource pool; generating a plurality of feedback bits corresponding to a set of candidate slots of the plurality of slots based at least in part on the time gap and the periodicity of the set of feedback occasions; and transmitting a feedback message comprising one or more indicators of the plurality of feedback bits on a feedback occasion of the set of feedback occasions that is located within a first slot of the sidelink resource pool.

Aspect 2: The method of aspect 1, wherein the set of candidate slots of the plurality of slots comprises one or more slots located between a first candidate slot occurring at the first number of slots before the first slot and a second candidate slot occurring at a second number of slots before the first slot.

Aspect 3: The method of aspect 2, wherein the second number of slots is equal to one slot less than a sum of the first number of slots and the periodicity of the set of feedback occasions.

Aspect 4: The method of any of aspects 2 through 3, wherein the second number of slots is equal to one slot less than a product of the periodicity of the set of feedback occasions and a number of feedback occasions associated with the feedback occasion of the set of feedback occasions.

Aspect 5: The method of aspect 4, wherein receiving the indication of the configuration comprises: receiving a radio resource control message indicating the number of feedback occasions.

Aspect 6: The method of any of aspects 4 through 5, wherein the number of feedback occasions is predefined.

Aspect 7: The method of any of aspects 1 through 6, further comprising: ordering the one or more indicators of the plurality of feedback bits in the feedback message according to a descending order of number of slots between each candidate slot of the set of candidate slots and the first slot, wherein each feedback bit of the plurality of feedback bits is associated with a respective candidate slot of the set of candidate slots.

Aspect 8: The method of any of aspects 1 through 7, further comprising: performing a listen-before-talk procedure, wherein the sidelink resource pool comprises unlicensed spectrum, and wherein transmitting the feedback message is based at least in part on determining that the listen-before-talk procedure is successful.

Aspect 9: The method of any of aspects 1 through 8, wherein generating the plurality of feedback bits comprises: generating the plurality of feedback bits associated with the set of candidate slots corresponding to a first priority level or a second priority level, wherein the first priority level is higher than the second priority level.

Aspect 10: The method of aspect 9, further comprising: receiving an indication of a second configuration to generate one plurality of feedback bits for the first priority level and the second priority level, wherein generating the plurality of feedback bits is based at least in part on the second configuration.

Aspect 11: The method of any of aspects 1 through 10, wherein generating the plurality of feedback bits comprises: generating the plurality of feedback bits associated with transmissions corresponding to a first priority level received over the set of candidate slots; and generating a second plurality of feedback bits associated with transmissions corresponding to a second priority level received over a second set of candidate slots, wherein the first priority level is higher than the second priority level.

Aspect 12: The method of aspect 11, further comprising: receiving an indicator of a number of priority levels comprising the first priority level and the second priority level, wherein generating the plurality of feedback bits and generating the second plurality of feedback bits are based at least in part on the indicator of the number of priority levels.

Aspect 13: The method of any of aspects 11 through 12, further comprising: receiving an indicator of a threshold priority level; and determining that the first priority level satisfies the threshold priority level and that the second priority level does not satisfy the threshold priority level, wherein generating the plurality of feedback bits and generating the second plurality of feedback bits are based at least in part on the determining.

Aspect 14: The method of any of aspects 11 through 13, further comprising: receiving an indication of a third configuration to generate the plurality of feedback bits and the second plurality of feedback bits corresponding to respective priority levels of a plurality of priority levels comprising the first priority level and the second priority level, wherein generating the plurality of feedback bits and generating the second plurality of feedback bits is based at least in part on the third configuration.

Aspect 15: A method for wireless communications at a wireless device, comprising: receiving an indicator of a configuration of a sidelink resource pool comprising a plurality of slots allocated for sidelink communication, the sidelink resource pool comprising a set of periodic feedback occasions; generating, for a first feedback occasion of the set of periodic feedback occasions, a first plurality of feedback bits corresponding to a first set of candidate slots of the plurality of slots and a second plurality of feedback bits corresponding to a second set of candidate slots of the plurality of slots; and transmitting the first plurality of feedback bits during the first feedback occasion based at least in part on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

Aspect 16: The method of aspect 15, further comprising: determining a first average weight value for the first set of candidate slots based at least in part on the first priority level and the number of detected transmissions associated with the first set of candidate slots and a second average weight value for the second set of candidate slots based at least in part on the second priority level and the number of detected transmissions associated with the second set of candidate slots.

Aspect 17: The method of aspect 16, further comprising: refraining from transmitting the second plurality of feedback bits during the first feedback occasion based at least in part on the first average weight value and the second average weight value.

Aspect 18: The method of any of aspects 16 through 17, further comprising: identifying a collision between the first plurality of feedback bits and the second plurality of feedback bits during the first feedback occasion; and determining the first average weight value and the second average weight value based at least in part on identifying the collision.

Aspect 19: The method of any of aspects 16 through 18, further comprising: determining a quantity of feedback messages for transmission in the first feedback occasion; and determining the first average weight value and the second average weight value based at least in part on determining that the quantity of feedback messages exceeds a threshold.

Aspect 20: The method of any of aspects 15 through 19, wherein the first priority level is higher than the second priority level.

Aspect 21: An apparatus for wireless communications at a first wireless device, comprising a processor; memory coupled with the processor; and instructions stored in the memory and executable by the processor to cause the apparatus to perform a method of any of aspects 1 through 14.

Aspect 22: An apparatus for wireless communications at a first wireless device, comprising at least one means for performing a method of any of aspects 1 through 14.

Aspect 23: A non-transitory computer-readable medium storing code for wireless communications at a first wireless device, the code comprising instructions executable by a processor to perform a method of any of aspects 1 through 14.

Aspect 24: An apparatus for wireless communications at a wireless device, comprising a processor; memory coupled with the processor; and instructions stored in the memory and executable by the processor to cause the apparatus to perform a method of any of aspects 15 through 20.

Aspect 25: An apparatus for wireless communications at a wireless device, comprising at least one means for performing a method of any of aspects 15 through 20.

Aspect 26: A non-transitory computer-readable medium storing code for wireless communications at a wireless device, the code comprising instructions executable by a processor to perform a method of any of aspects 15 through 20.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first wireless device, comprising:
receiving an indicator of a configuration of a sidelink resource pool comprising a plurality of slots allocated for sidelink communication, a time gap comprising a first number of slots for generating feedback for one or more slots of the sidelink resource pool, and a periodicity of a set of feedback occasions within the sidelink resource pool;
generating a plurality of feedback bits corresponding to a set of candidate slots of the plurality of slots based at least in part on the time gap and the periodicity of the set of feedback occasions; and
transmitting a feedback message comprising one or more indicators of the plurality of feedback bits on a feedback occasion of the set of feedback occasions that is located within a first slot of the sidelink resource pool.

2. The method of claim 1, wherein the set of candidate slots of the plurality of slots comprises one or more slots located between a first candidate slot occurring at the first number of slots before the first slot and a second candidate slot occurring at a second number of slots before the first slot.

3. The method of claim 2, wherein the second number of slots is equal to one slot less than a sum of the first number of slots and the periodicity of the set of feedback occasions.

4. The method of claim 2, wherein the second number of slots is equal to one slot less than a product of the periodicity of the set of feedback occasions and a number of feedback occasions associated with the feedback occasion of the set of feedback occasions.

5. The method of claim 4, wherein receiving the indication of the configuration comprises:
receiving a radio resource control message indicating the number of feedback occasions.

6. The method of claim 4, wherein the number of feedback occasions is predefined.

7. The method of claim 1, further comprising:
ordering the one or more indicators of the plurality of feedback bits in the feedback message according to a descending order of number of slots between each candidate slot of the set of candidate slots and the first slot, wherein each feedback bit of the plurality of feedback bits is associated with a respective candidate slot of the set of candidate slots.

8. The method of claim 1, further comprising:
performing a listen-before-talk procedure, wherein the sidelink resource pool comprises unlicensed spectrum, and wherein transmitting the feedback message is based at least in part on determining that the listen-before-talk procedure is successful.

9. The method of claim 1, wherein generating the plurality of feedback bits comprises:
generating the plurality of feedback bits associated with the set of candidate slots corresponding to a first priority level or a second priority level, wherein the first priority level is higher than the second priority level.

10. The method of claim 9, further comprising:
receiving an indication of a second configuration to generate one plurality of feedback bits for the first priority level and the second priority level, wherein generating the plurality of feedback bits is based at least in part on the second configuration.

11. The method of claim 1, wherein generating the plurality of feedback bits comprises:
generating the plurality of feedback bits associated with transmissions corresponding to a first priority level received over the set of candidate slots; and
generating a second plurality of feedback bits associated with transmissions corresponding to a second priority level received over a second set of candidate slots, wherein the first priority level is higher than the second priority level.

12. The method of claim 11, further comprising:
receiving an indicator of a number of priority levels comprising the first priority level and the second priority level, wherein generating the plurality of feedback bits and generating the second plurality of feedback bits are based at least in part on the indicator of the number of priority levels.

13. The method of claim 11, further comprising:
receiving an indicator of a threshold priority level; and
determining that the first priority level satisfies the threshold priority level and that the second priority level does not satisfy the threshold priority level, wherein generating the plurality of feedback bits and generating the second plurality of feedback bits are based at least in part on the determining.

14. The method of claim 11, further comprising:
receiving an indication of a third configuration to generate the plurality of feedback bits and the second plurality of feedback bits corresponding to respective priority levels of a plurality of priority levels comprising the first priority level and the second priority level, wherein generating the plurality of feedback bits and generating the second plurality of feedback bits is based at least in part on the third configuration.

15. A method for wireless communications at a wireless device, comprising:
receiving an indicator of a configuration of a sidelink resource pool comprising a plurality of slots allocated for sidelink communication, the sidelink resource pool comprising a set of periodic feedback occasions;
generating, for a first feedback occasion of the set of periodic feedback occasions, a first plurality of feedback bits corresponding to a first set of candidate slots of the plurality of slots and a second plurality of feedback bits corresponding to a second set of candidate slots of the plurality of slots; and
transmitting the first plurality of feedback bits during the first feedback occasion based at least in part on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

16. The method of claim 15, further comprising:
determining a first average weight value for the first set of candidate slots based at least in part on the first priority level and the number of detected transmissions associated with the first set of candidate slots and a second average weight value for the second set of candidate slots based at least in part on the second priority level and the number of detected transmissions associated with the second set of candidate slots.

17. The method of claim 16, further comprising:
refraining from transmitting the second plurality of feedback bits during the first feedback occasion based at least in part on the first average weight value and the second average weight value.

18. The method of claim 16, further comprising:
identifying a collision between the first plurality of feedback bits and the second plurality of feedback bits during the first feedback occasion; and
determining the first average weight value and the second average weight value based at least in part on identifying the collision.

19. The method of claim 16, further comprising:
determining a quantity of feedback messages for transmission in the first feedback occasion; and
determining the first average weight value and the second average weight value based at least in part on determining that the quantity of feedback messages exceeds a threshold.

20. The method of claim 15, wherein the first priority level is higher than the second priority level.

21. An apparatus for wireless communications at a first wireless device, comprising:
a processor;
memory coupled with the processor; and
instructions stored in the memory and executable by the processor to cause the apparatus to:
receive an indicator of a configuration of a sidelink resource pool comprising a plurality of slots allocated for sidelink communication, a time gap comprising a first number of slots for generating feedback for one or more slots of the sidelink resource pool, and a periodicity of a set of feedback occasions within the sidelink resource pool;
generate a plurality of feedback bits corresponding to a set of candidate slots of the plurality of slots based at least in part on the time gap and the periodicity of the set of feedback occasions; and
transmit a feedback message comprising one or more indicators of the plurality of feedback bits on a feedback occasion of the set of feedback occasions that is located within a first slot of the sidelink resource pool.

22. The apparatus of claim 21, wherein the set of candidate slots of the plurality of slots comprises one or more slots located between a first candidate slot occurring at the first number of slots before the first slot and a second candidate slot occurring at a second number of slots before the first slot.

23. The apparatus of claim 22, wherein the second number of slots is equal to one slot less than a sum of the first number of slots and the periodicity of the set of feedback occasions.

24. The apparatus of claim 22, wherein the second number of slots is equal to one slot less than a product of the periodicity of the set of feedback occasions and a number of feedback occasions associated with the feedback occasion of the set of feedback occasions.

25. The apparatus of claim 21, wherein the instructions are further executable by the processor to cause the apparatus to:
order the one or more indicators of the plurality of feedback bits in the feedback message according to a descending order of number of slots between each candidate slot of the set of candidate slots and the first slot, wherein each feedback bit of the plurality of feedback bits is associated with a respective candidate slot of the set of candidate slots.

26. An apparatus for wireless communications at a wireless device, comprising:
a processor;
memory coupled with the processor; and
instructions stored in the memory and executable by the processor to cause the apparatus to:
receive an indicator of a configuration of a sidelink resource pool comprising a plurality of slots allocated for sidelink communication, the sidelink resource pool comprising a set of periodic feedback occasions;
generate, for a first feedback occasion of the set of periodic feedback occasions, a first plurality of feedback bits corresponding to a first set of candidate slots of the plurality of slots and a second plurality of feedback bits corresponding to a second set of candidate slots of the plurality of slots; and
transmit the first plurality of feedback bits during the first feedback occasion based at least in part on a first priority level for transmissions received over the first set of candidate slots, a second priority level for transmissions received over the second set of candidate slots, a number of detected transmissions associated with the first set of candidate slots, and a number of detected transmissions associated with the second set of candidate slots.

27. The apparatus of claim 26, wherein the instructions are further executable by the processor to cause the apparatus to:
determine a first average weight value for the first set of candidate slots based at least in part on the first priority level and the number of detected transmissions associated with the first set of candidate slots and a second average weight value for the second set of candidate slots based at least in part on the second priority level and the number of detected transmissions associated with the second set of candidate slots.

28. The apparatus of claim 27, wherein the instructions are further executable by the processor to cause the apparatus to:
refrain from transmitting the second plurality of feedback bits during the first feedback occasion based at least in part on the first average weight value and the second average weight value.

29. The apparatus of claim 27, wherein the instructions are further executable by the processor to cause the apparatus to:
identify a collision between the first plurality of feedback bits and the second plurality of feedback bits during the first feedback occasion; and
determine the first average weight value and the second average weight value based at least in part on identifying the collision.

30. The apparatus of claim 27, wherein the instructions are further executable by the processor to cause the apparatus to:
determine a quantity of feedback messages for transmission in the first feedback occasion; and
determine the first average weight value and the second average weight value based at least in part on determining that the quantity of feedback messages exceeds a threshold.
